(19) United States
(12) Patent Application Publication
(10) Pub. No.: US 2017/0289542 A1
(43) Pub. Date: Oct. 5, 2017

(54) IMAGE ENCODING DEVICE AND IMAGE ENCODING METHOD

(71) Applicant: FUJITSU LIMITED, Kawasaki-shi (JP)

(72) Inventors: Shinji URANAKA, Fukuoka (JP); CHIKARA IMAJO, Fukuoka (JP); YASUO MISUDA, Inagi (JP)

(73) Assignee: FUJITSU LIMITED, Kawasaki-shi (JP)

(21) Appl. No.: 15/461,641

(22) Filed: Mar. 17, 2017

(30) Foreign Application Priority Data
Mar. 29, 2016 (JP) 2016-066071

(51) Int. Cl. H04N 19/107; H04N 19/105; H04N 19/119

(52) U.S. Cl. CPC H04N 19/107; H04N 19/119; H04N 19/105; H04N 19/176

(57) ABSTRACT

A first encoder encodes an input image by using a first encoding algorithm. A memory stores a decoded image obtained by decoding a code generated by the first encoder. A converter converts a shape of a block of the input image that is segmented into a plurality of blocks. A second encoder encodes the block converted by the converter according to the decoded image by using a second encoding algorithm that is different from the first encoding algorithm.

### CROSS-REFERENCE TO RELATED APPLICATION

This application is based upon and claims the benefit of priority of the prior Japanese Patent Application No. 2016-066071, filed on Mar. 29, 2016, the entire contents of which are incorporated herein by reference.

### FIELD

The embodiments discussed herein are related to an image encoding device and an image encoding method.

### BACKGROUND

In recent years, high-quality high-compression video contents have been distributed. A high-quality video content has a large amount of information, and therefore H.264 or High Efficiency Video Coding (HEVC), which is a moving image encoding algorithm to achieve highly efficient compression, is often used. HEVC is the latest standard for moving image encoding, and can achieve a compression efficiency that is about twice as high as H.264. On the other hand, H.264 is used in various products.

At the site of video distribution in which a real-time nature is desired, such as a live broadcast on TV, both of the encoded streams according to highly efficient HEVC and widely used H.264 are sometimes output simultaneously. In this case, two types of image encoding devices that respectively implement HEVC and H.264 encoding algorithms are used to simultaneously output two types of encoded streams.

An image encoding device that simultaneously generates a Moving Picture Experts Group (MPEG) stream and a Joint Photographic Experts Group (JPEG) stream is also known (see, for example, Patent Document 1). A moving image encoding device that simultaneously generates encoded data of MPEG-2 and MPEG-4 is also known (see, for example, Patent Document 2).

Patent Document 1: Japanese Laid-open Patent Publication No. 2000-50263

Patent Document 2: Japanese Laid-open Patent Publication No. 2008-61270

### SUMMARY

According to an aspect of the embodiments, an image encoding device includes a first encoder, a second encoder, a memory, and a converter.

The first encoder encodes an input image by using a first encoding algorithm. The memory stores a decoded image obtained by decoding a code generated by the first encoder. The converter converts a shape of a block of the input image that is segmented into a plurality of blocks. The second encoder encodes the block converted by the converter according to the decoded image by using a second encoding algorithm that is different from the first encoding algorithm.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an image encoding device;

FIG. 2 is a block diagram illustrating a mode determination circuit;

FIG. 3 illustrates a block according to H.264;

FIG. 4 illustrates inter-prediction and intra-prediction according to H.264;

FIG. 5 illustrates a block according to HEVC;

FIG. 6 illustrates inter-prediction and intra-prediction according to HEVC;

FIG. 7 is a block diagram illustrating an encoder;

FIG. 8 is a block diagram illustrating an image encoding system;

FIG. 9 is a block diagram illustrating an image encoding device that shares a decoded image;

FIG. 10 is a flowchart of image encoding processing;

FIG. 11 is a block diagram illustrating a first specific example of an image encoding device;

FIG. 12 is a flowchart illustrating a first specific example of image encoding processing;

FIG. 13 illustrates a decoded image area;

FIG. 14 illustrates mode conversion processing;

FIG. 15 illustrates a first correspondence relationship between a PU and an MB;

FIG. 16 illustrates a second correspondence relationship between a PU and an MB;

FIG. 17 illustrates a third correspondence relationship between a PU and an MB;

FIG. 18 illustrates a fourth correspondence relationship between a PU and an MB;

FIG. 19 illustrates a fifth correspondence relationship between a PU and an MB;

FIG. 20 illustrates a sixth correspondence relationship between a PU and an MB;

FIG. 21 is a block diagram illustrating a mode determination circuit using a decoded image;

FIG. 22 illustrates processing for reading a decoded image;

FIG. 23 is a block diagram illustrating a second specific example of an image encoding device;

FIG. 24 is a block diagram illustrating a difference encoder;

FIG. 25 illustrates a quantization information storage and a difference image storage;

FIG. 26 is a block diagram illustrating a difference decoder;

FIG. 27 illustrates a reference area extending over a plurality of areas;

FIG. 28 is a flowchart illustrating a second specific example of image encoding processing;

FIG. 29 is a block diagram illustrating a third specific example of an image encoding device;

FIG. 30 is a block diagram illustrating an encoder that performs difference image encoding and difference code decoding;

FIG. 31 illustrates a rate controller;

FIG. 32 illustrates an accumulated generated-information amount;

FIG. 33 illustrates skip information;

FIG. 34 illustrates an accumulated generated-information amount that reaches an upper limit;

FIG. 35 illustrates peripheral pixels;

FIG. 36 illustrates intra-prediction modes according to HEVC;

FIG. 37 illustrates intra-prediction modes of a 4×4 luminance block according to H.264;

FIG. 38 illustrates intra-prediction modes of a 16×16 luminance block according to H.264;

FIG. 39 illustrates intra-prediction modes of a color difference block according to H.264;

FIG. 40 illustrates a seventh correspondence relationship between a PU and an MB;

FIG. 41 illustrates an eighth correspondence relationship between a PU and an MB;

FIG. 42 illustrates a first correspondence relationship with a prediction direction;

FIG. 43 illustrates a ninth correspondence relationship between a PU and an MB;

FIG. 44 illustrates a correspondence relationship between a PU and a color difference block;

FIG. 45 illustrates a second correspondence relationship with a prediction direction;

FIG. 46 illustrates peripheral pixels that have not yet been encoded;

FIG. 47 illustrates encoded peripheral pixels; and

FIG. 48 is a block diagram illustrating an information processing device.

### DESCRIPTION OF EMBODIMENTS

Embodiments are described below in detail with reference to the drawings.

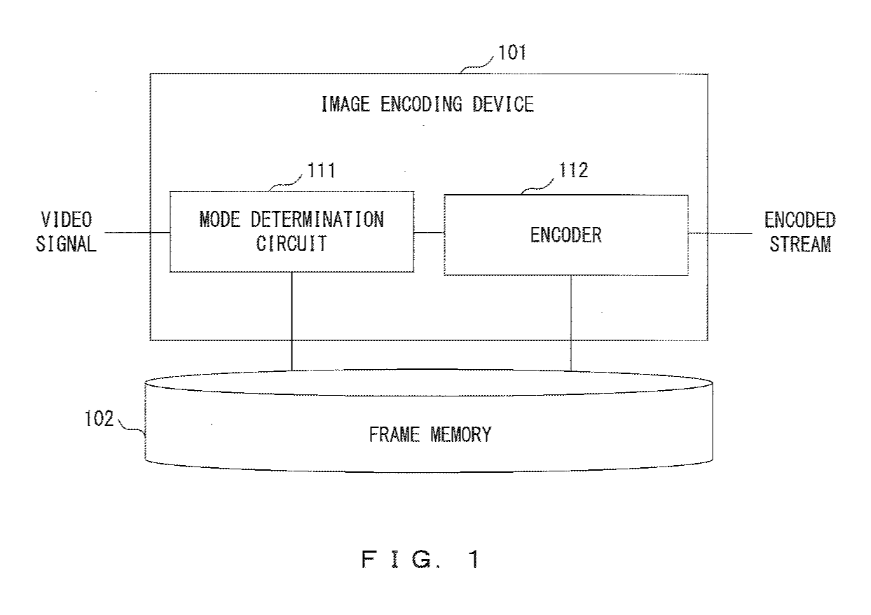

FIG. 1 illustrates an exemplary configuration of an image encoding device. An image encoding device 101 of FIG. 1 includes a mode determination circuit 111 and an encoder 112, and the image encoding device 101 encodes an input video signal according to an encoding algorithm such as H.264 or HEVC.

The video signal includes a plurality of images at respective times. Each of the plurality of images is input as an image to be encoded (an original image) to the image encoding device 101. Each of the images may be a color image, or may be a monochrome image. When each of the images is a color image, a pixel value may be in the RGB format, or may be in the YUV format. Each of the images may be referred to as a picture or a frame.

The mode determination circuit 111 performs intra-prediction and inter-prediction on a video signal, selects a prediction mode having the smallest encoding error, and outputs mode information indicating the selected prediction mode to the encoder 112.

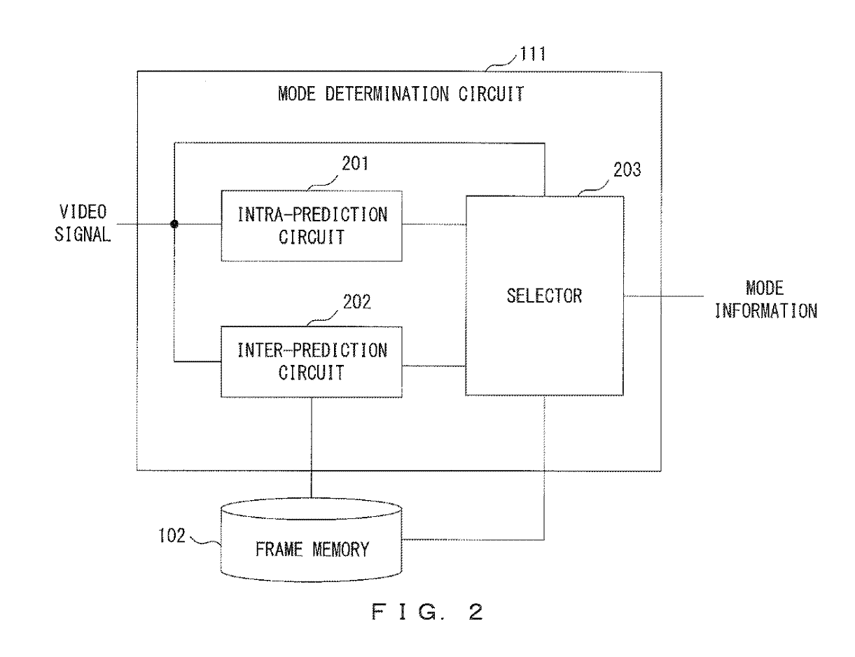

FIG. 2 illustrates an exemplary configuration of the mode determination circuit 111 of FIG. 1. A mode determination circuit 111 of FIG. 2 includes an intra-prediction circuit 201, an inter-prediction circuit 202, and a selector 203, and the mode determination circuit 111 divides an image to be encoded into blocks, and processes each of the blocks as a block to be encoded.

The intra-prediction circuit 201 generates an intra-prediction block image of the block to be encoded that has the smallest encoding error, from a pixel value of a peripheral pixel that has already been encoded within the image to be encoded. The inter-prediction circuit 202 reads a reference image used for motion search from a frame memory 102 that is an external memory, and performs motion compensation on the block to be encoded so as to generate an inter-prediction block image that has the smallest encoding error.

The selector 203 selects a prediction mode that has a smaller encoding error from among intra-prediction and inter-prediction, and outputs mode information including the shape of the block to be encoded, prediction information, and the like. When intra-prediction is selected, the prediction information includes a prediction direction, and when inter-prediction is selected, the prediction information includes information relating to the reference image and a motion vector.

The encoder 112 encodes the block to be encoded according to the mode information, and outputs an encoded stream. The encoder 112 performs frequency conversion, quantization, and entropy encoding on a prediction error signal indicating a difference between the block to be encoded and the intra-prediction block image or the inter-prediction block image so as to generate an encoded stream.

At this time, the encoder 112 performs inverse quantization and inverse frequency conversion on a quantization result of the block to be encoded so as to generate a reconfigured prediction error signal, and adds the prediction block image and the reconfigured prediction error signal so as to generate a decoded image. The encoder 112 outputs the generated decoded image to the frame memory 102. The frame memory 102 stores the decoded image, and outputs the stored decoded image as a reference image used to perform inter-prediction on another image to the mode determination circuit 111.

The image encoding device 101 transmits the generated encoded stream to an image decoding device (not illustrated), and the image decoding device decodes the encoded stream, and restores a video signal. The image encoding device 101 can also use H.261, H.262, H.263, MPEG-1, MPEG-2, MPEG-4, or the like, which is an earlier moving image encoding algorithm of H.264.

The image encoding device 101 is used for various purposes. As an example, the image encoding device 101 can also be incorporated into a video camera, a video transmitter, a video receiver, a video telephone system, a computer, or a portable telephone.

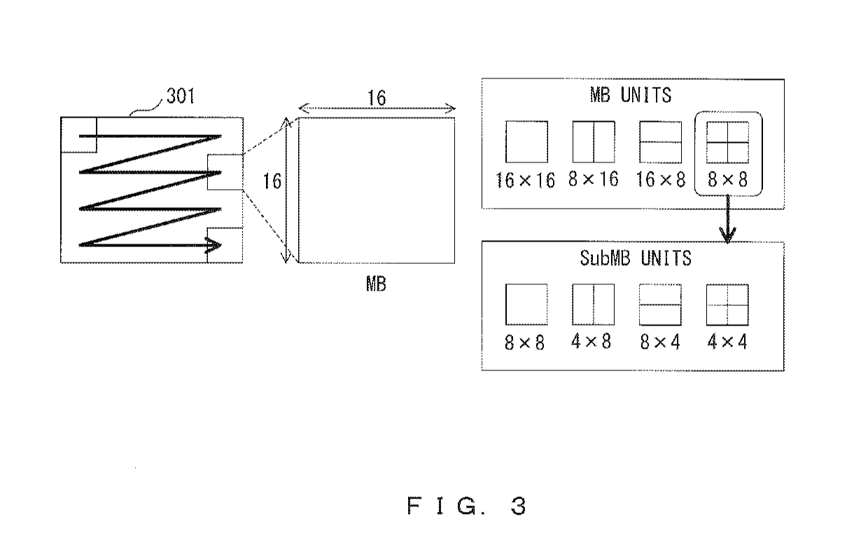

FIG. 3 illustrates an example of a block according to H.264. The shape of a block according to H.264 is defined by the size of a macroblock (MB), and an image to be encoded 301 is divided into units of four types (16×16, 16×8, 8×16, and 8×8) of MBs. An 8×8 MB can also be further divided into units of 8×4, 4×8, or 4×4 sub-macroblocks (SubMBs).

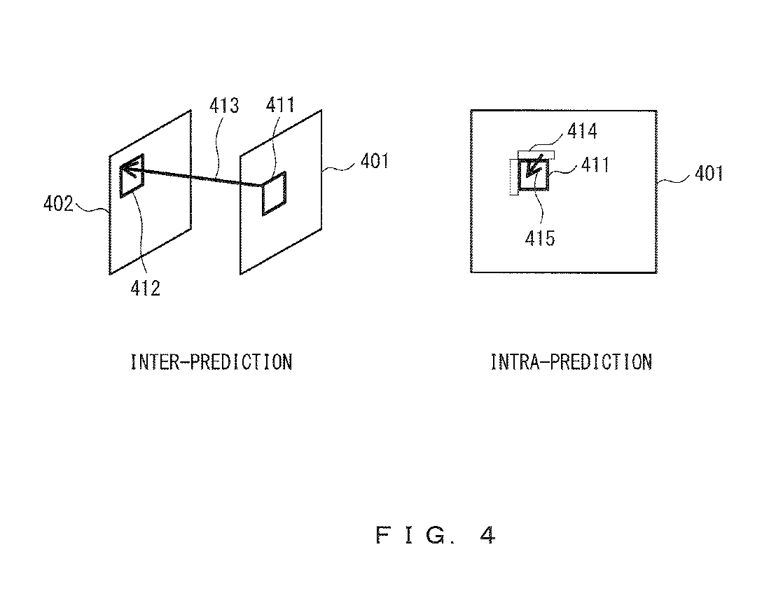

FIG. 4 illustrates examples of inter-prediction and intra-prediction according to H.264. In the case of inter-prediction, a reference image 402 and a motion vector 413 pointing at an MB 412 in the reference image 402 are determined for an MB 411 in an image to be encoded 401, and mode information indicating the reference image 402 and the motion vector 413 is generated. The same reference image 402 is selected for a plurality of SubMBs included in the MB 411.

In the case of intra-prediction, a prediction direction 415 defining a peripheral pixel 414 is determined for the MB 411, and mode information including the prediction direction 415 is generated.

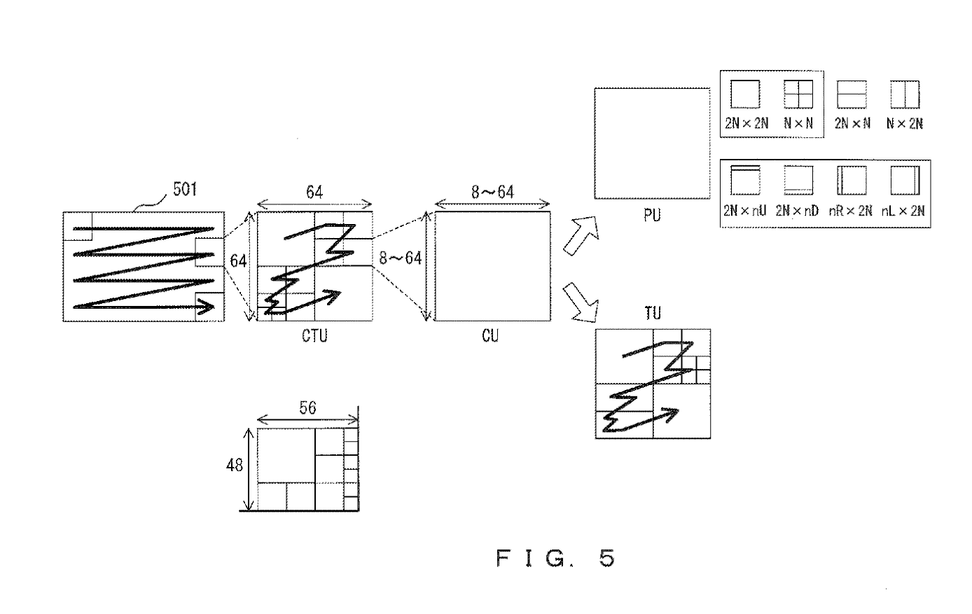

FIG. 5 illustrates an example of a block according to HEVC. The shape of a block according to HEVC can be freely defined on the basis of a coding tree unit (CTU). An image to be encoded 501 is divided into units of CTUs having a quadtree structure, each of the CPUs is divided into units of coding units (CUs), and each of the CUs is further divided into units of prediction units (PUs) and transform units (TUs). The shape of each of the units is described below.

CTU: 16×16 to 64×64

CU: 8×8 to the size of CTU

PU: 2N×2N, N×N, 2N×N, N×2N,
2N×nU, 2N×nD, nR×2N, nL×2N
(2N×2N has the size of CU.)

TU: 4×4 to 32×32 (equal to or smaller than the size of CU)

When the size in a horizontal direction or a vertical direction of the image to be encoded 501 is not the integer multiple of 64, a CTU at the end of the image to be encoded 501 may be set to have a shape such as 56×48. A CU corresponds to a block to be encoded, and switching of inter-prediction and intra-prediction, switching of a quantization parameter, and the like are performed for each of the CUs.

A PU is a unit for determining a prediction mode, and a divided shape of the PU can be set independently of a TU. In the case of intra-prediction, a prediction direction is determined for each of the PUs, and in the case of inter-prediction, a reference image and a motion vector are determined for each of the PUs. From among the shapes of the PU, 2N×nU, 2N×nD, nR×2N, and nL×2N indicate asymmetric divided shapes. In intra-prediction, 2N×2N or N×N is used.

The TU is a unit for performing orthogonal transformation on a prediction error signal, and a divided shape of the TU can be set to have a quadtree structure independently of the PU. In the case of intra-prediction, the size of the TU is smaller than or equal to the size of the PU.

The CTU, the CU, the PU, and the TU may be referred to as a coding tree block (CTB), a coding block (CB), a prediction block (PB), and a transform block (TB), respectively.

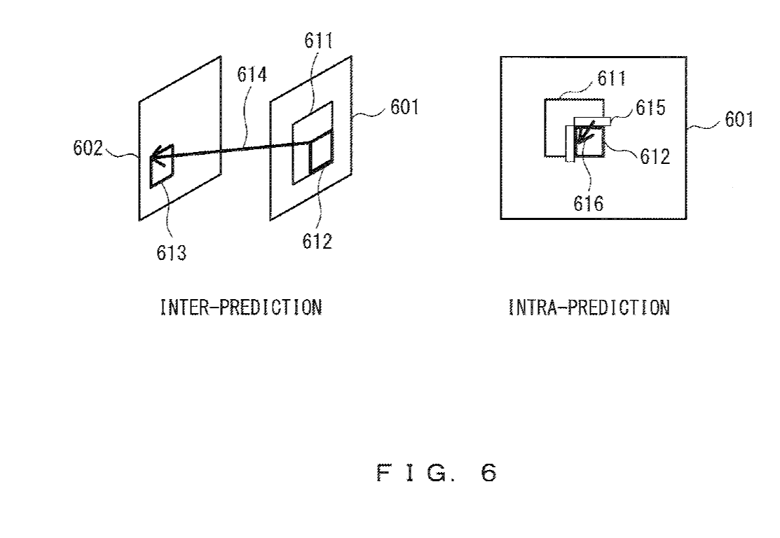

FIG. 6 illustrates examples of inter-prediction and intra-prediction according to HEVC. In the case of inter-prediction, a reference image 602 and a motion vector 614 pointing at a PU 613 in the reference image 602 are determined for a PU 612 included in a CTU 611 within an image to be encoded 601, and mode information indicating the reference image 602 and the motion vector 614 is generated.

In the case of intra-prediction, a prediction direction 616 defining a peripheral pixel 615 is determined for the PU 612, and mode information including the prediction direction 616 is generated.

As described above, HEVC is an encoding algorithm having a larger degree of freedom than H.264.

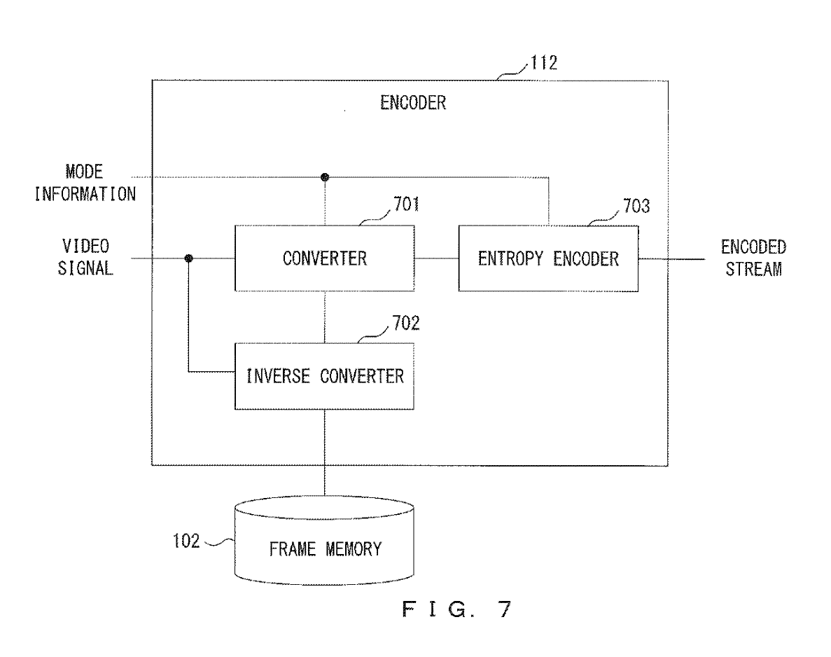

FIG. 7 illustrates an exemplary configuration of the encoder 112 of FIG. 1. An encoder 112 of FIG. 7 includes a converter 701, an inverse converter 702, and an entropy encoder 703. The converter 701 performs frequency conversion and quantization on the prediction error signal generated by the mode determination circuit 111 so as to generate a compression coefficient, and the entropy encoder 703 performs entropy encoding on the compression coefficient so as to generate an encoded stream. The compression coefficient generated by the converter 701 corresponds to a code indicating a quantization result.

The inverse converter 702 performs inverse quantization and inverse frequency conversion on the compression coefficient generated by the converter 701 so as to generate a reconfigured prediction error signal, and the inverse converter 702 adds a prediction block image that the mode determination circuit 111 has used for prediction and the reconfigured prediction error signal so as to generate a decoded image. The inverse converter 702 outputs the generated decoded image to the frame memory 102.

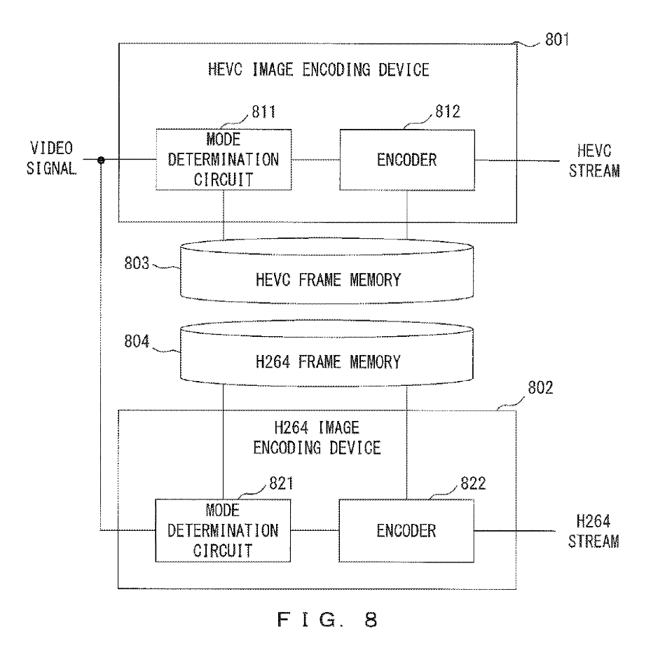

FIG. 8 illustrates an exemplary configuration of an image encoding system that simultaneously outputs both of the encoded streams according to HEVC and H.264 in a live broadcast on TV, or the like. The image encoding system of FIG. 8 includes an HEVC image encoding device 801, an H264 image encoding device 802, an HEVC frame memory 803, and an H264 frame memory 804.

The HEVC image encoding device 801 includes a mode determination circuit 811 and an encoder 812, and the HEVC image encoding device 801 encodes a video signal according to HEVC, and outputs an HEVC stream. The encoder 812 outputs a decoded image to the HEVC frame memory 803. The mode determination circuit 811 reads the decoded image from the HEVC frame memory 803, and uses the read decoded image as a reference image.

The H264 image encoding device 802 includes a mode determination circuit 821 and an encoder 822, and the H264 image encoding device 802 encodes a video signal according to H.264, and outputs an H264 stream. The encoder 822 outputs a decoded image to the H264 frame memory 804. The mode determination circuit 821 reads the decoded image from the H264 frame memory 804, and uses the read decoded image as a reference image.

In this case, the HEVC image encoding device 801 and the H264 image encoding device 802 operate independently of each other in order to simultaneously output two types of encoded streams, the HEVC stream and the H264 stream. Accordingly, an image encoding device and a frame memory are provided for each of the encoded streams, and the circuit scale of the image encoding system increases.

In addition, it is assumed that an image having a large size is encoded according to HEVC and H.264 in comparison with an earlier encoding algorithm of H.264. As an example, a 4K (such as 3840×2160) image can be encoded according to HEVC and H.264, and at largest 8K (such as 7680×4320) image can be encoded according to HEVC. 4K is 4 times as large as FullHD (1920×1080) that is handled according to an earlier encoding algorithm of H.264, and 8K is 16 times as large as FullHD.

Accordingly, the capacity and a memory access band of a frame memory that stores a decoded image also increase 4 times or 16 times in proportion to the size of an image. In a case in which two types of encoding according to HEVC and H.264 are performed simultaneously, the capacity and the memory access band of the frame memory are further doubled. Accordingly, it is preferable that improvements be made to control of the frame memory in order to reduce the circuit scale.

The problem above does not arise only in a case in which encoded streams according to HEVC and H.264 are generated, but also arises in a case in which two types of encoded streams are generated according to other encoding algorithms.

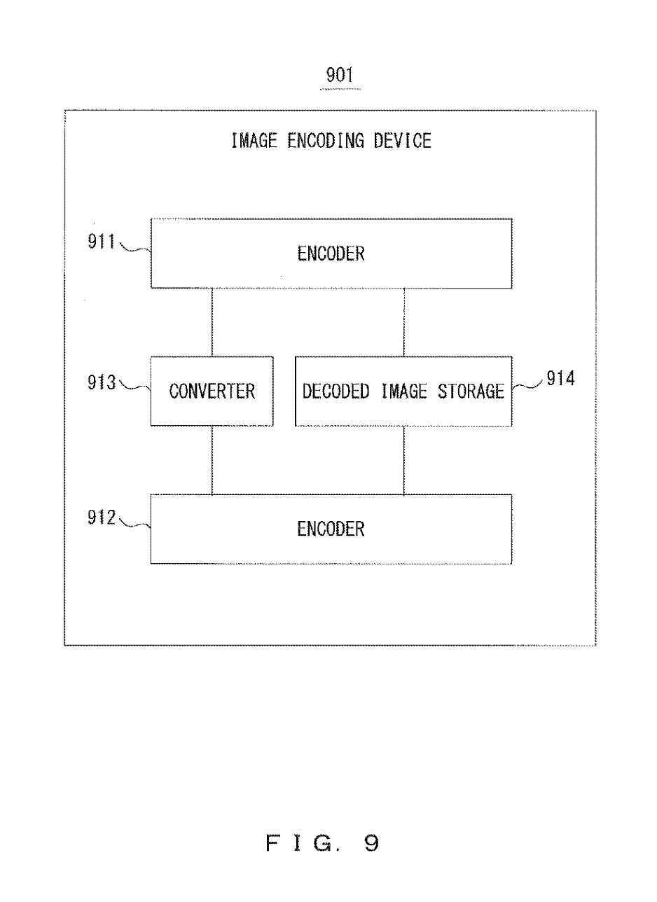

FIG. 9 illustrates an exemplary configuration of an image encoding device that shares a decoded image. An image encoding device 901 of FIG. 9 includes an encoder 911, an encoder 912, a converter 913, and a decoded image storage 914.

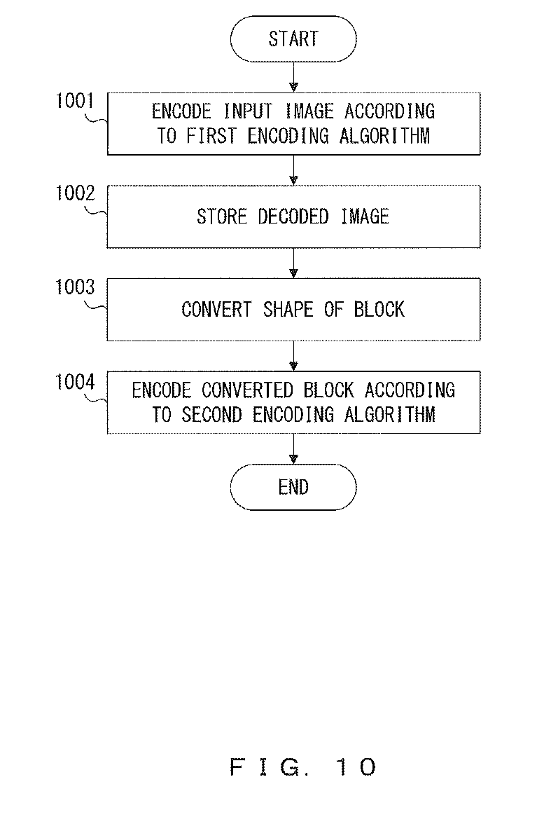

FIG. 10 is a flowchart illustrating an example of image encoding processing performed by the image encoding device 901 of FIG. 9. First, the encoder 911 encodes an input image according to a first encoding algorithm (step 1001), and stores a decoded image obtained by decoding a generated code in the decoded image storage 914 (step 1002).

Then, the converter 913 converts the shape of a block of the input image that has been segmented into a plurality of blocks (step 1003). The encoder 912 encodes the block converted by the converter 913 on the basis of the decoded image stored in the decoded image storage 914 by using a second encoding algorithm that is different form the first encoding algorithm (step 1004).

By employing the image encoding device 901 above, the capacity of a memory at the time of encoding an image according to two types of encoding algorithms can be reduced.

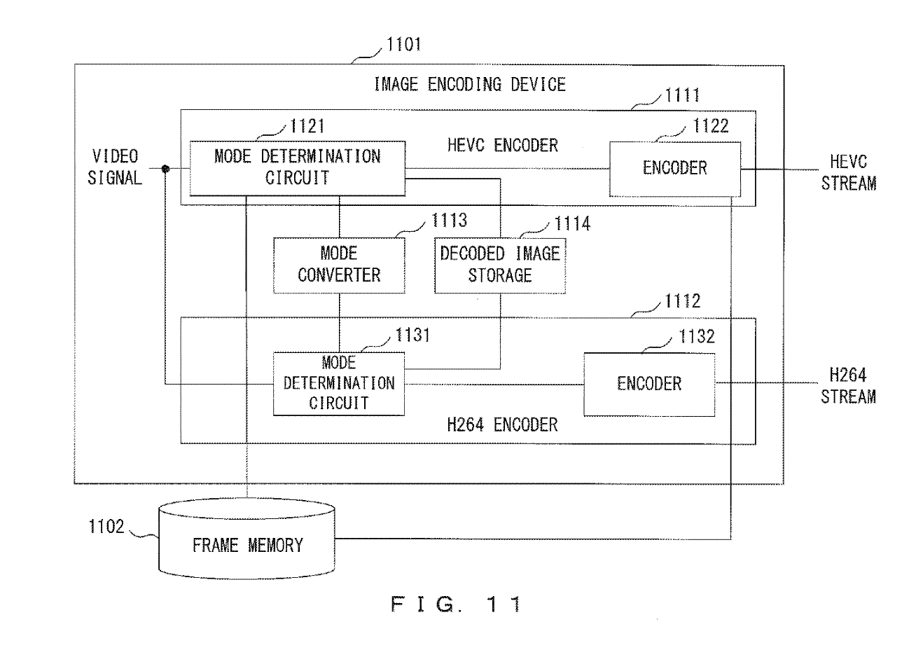

FIG. 11 illustrates a first specific example of the image encoding device 901 of FIG. 9. An image encoding device 1101 of FIG. 11 includes an HEVC encoder 1111, an H264 encoder 1112, a mode converter 1113, and a decoded image storage 1114. The HEVC encoder 1111 includes a mode determination circuit 1121 and an encoder 1122, and the H264 encoder 1112 includes a mode determination circuit 1131 and an encoder 1132.

Respective components of the image encoding device 1101 can be implemented, for example, as hardware circuits.

The HEVC encoder 1111, the H264 encoder 1112, the mode converter 1113, and the decoded image storage 1114 respectively correspond to the encoder 911, the encoder 912, the converter 913, and the decoded image storage 914 of FIG. 9.

The mode determination circuit 1121 of the HEVC encoder 1111 performs intra-prediction and inter-prediction according to HEVC on a video signal, and outputs HEVC mode information indicating a selected prediction mode to the encoder 1122. The mode determination circuit 1121 outputs mode information of inter-prediction to the mode converter 1113, and also outputs a decoded image used in inter-prediction to the decoded image storage 1114. The mode converter 1113 converts mode information of inter-prediction according to HEVC into mode information of inter-prediction according to H.264, and outputs the mode information of inter-prediction according to H.264 to the mode determination circuit 1131.

The encoder 1122 encodes a block to be encoded according to the HEVC mode information by using HEVC, and outputs an HEVC stream. At this time, the encoder 1122 outputs a generated decoded image to a frame memory 1102. The frame memory 1102 stores the decoded image, and outputs the stored decoded image as a reference image used to perform inter-prediction on another image to the mode determination circuit 1121.

The mode determination circuit 1131 of the H264 encoder 1112 performs intra-prediction according to H.264 on a video signal, and generates an intra-prediction block image. The mode determination circuit 1131 also reads the decoded image from the decoded image storage 1114 in accordance with the mode information of inter-prediction according to H.264 that has been received from the mode converter 1113, and uses the read decoded image as an inter-prediction block image. The mode determination circuit 1131 selects a prediction mode by using the intra-prediction block image and the inter-prediction block image, and outputs H264 mode information indicating the selected prediction mode to the encoder 1132.

The encoder 1132 encodes a block to be encoded according to the H264 mode information by using H.264, and outputs an H264 stream.

By providing the mode converter 1113 and the decoded image storage 1114, mode information of inter-prediction and a decoded image can be transferred from the HEVC encoder 1111 to the H264 encoder 1112. Consequently, the same decoded image can be shared by the HEVC encoder 1111 and the H264 encoder 1112, and therefore the H264 frame memory 804 of FIG. 8 can be omitted.

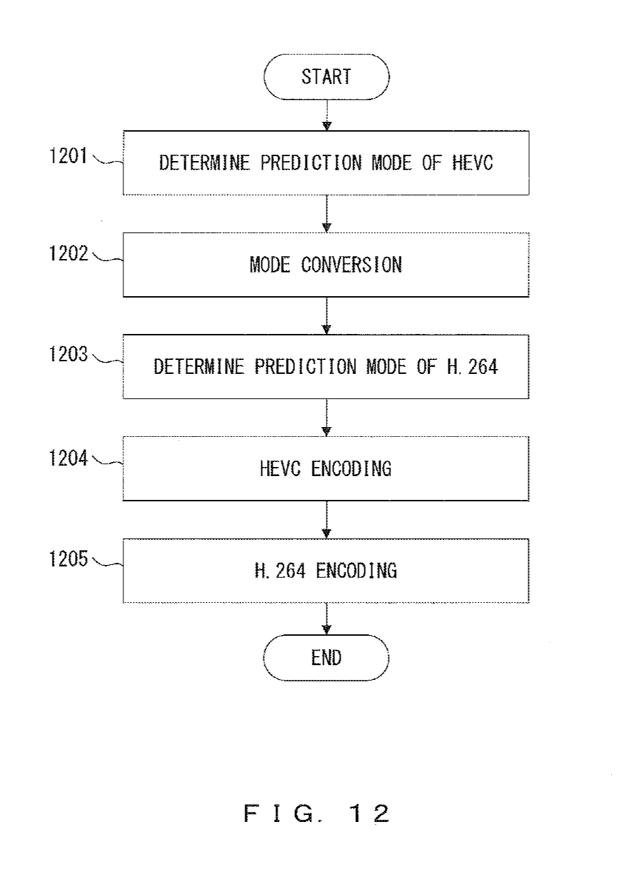

FIG. 12 is a flowchart illustrating a first specific example of image encoding processing performed by the image encoding device 1101 of FIG. 11. First, the mode determination circuit 1121 determines a prediction mode of HEVC, and outputs HEVC mode information to the encoder 1122 (step 1201). At this time, the mode determination circuit 1121 outputs, to the decoded image storage 1114, a decoded image read from the frame memory 1102 in inter-prediction.

The decoded image storage 1114 is, for example, a buffer that stores a decoded image, and includes a prescribed number of decoded image areas that corresponds to the number of reference images. The size in the horizontal direction of each of the decoded image areas is the same as the size in the horizontal direction of an image to be encoded, and the size in the vertical direction is the same as the size in the vertical direction of a CTU. Every time inter-prediction finishes to be performed on one CTU, the mode determination circuit 1121 writes the decoded image read from the frame memory 1102 in inter-prediction performed on the CTU to the decoded image storage 1114.

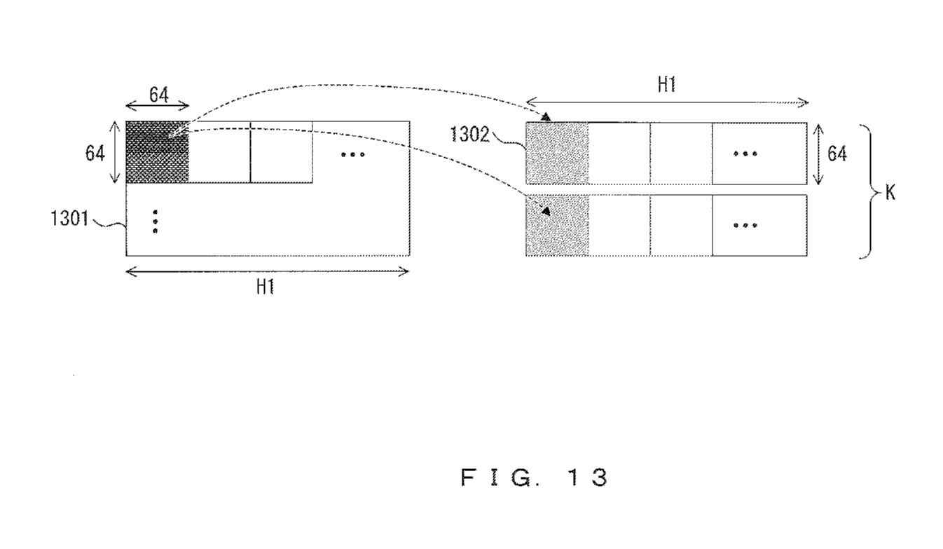

FIG. 13 illustrates an example of a decoded image area in the decoded image storage 1114. When K reference images are used, K decoded image areas 1302 are provided in the decoded image storage 1114. When the size in the horizontal direction of an image to be encoded 1301 is H1 and the shape of a CTU is 64×64, the size in the horizontal direction of the decoded image area 1302 is H1, and the size in the vertical direction is 64. By providing the decoded image storage 1114 above, a difference between the size (64×64, 32×32, or 16×16) of a CTU according to HEVC and the size (16×16) of an MB according to H.264 can be absorbed.

Then, the mode converter 1113 converts mode information of inter-prediction according to HEVC into mode information of inter-prediction according to H.264 (step 1202). At this time, the mode converter 1113 converts the shape and a motion vector of a block that has the highest encoding efficiency in the prediction mode according to HEVC into the shape and a motion vector of a block that can be used according to H.264. In a case in which a block according to HEVC fails to be simply diverted due to a difference in an allowable shape of a block between HEVC and H.264, the mode converter 1113 appropriately converts the block according to HEVC into a block that can be used according to H.264.

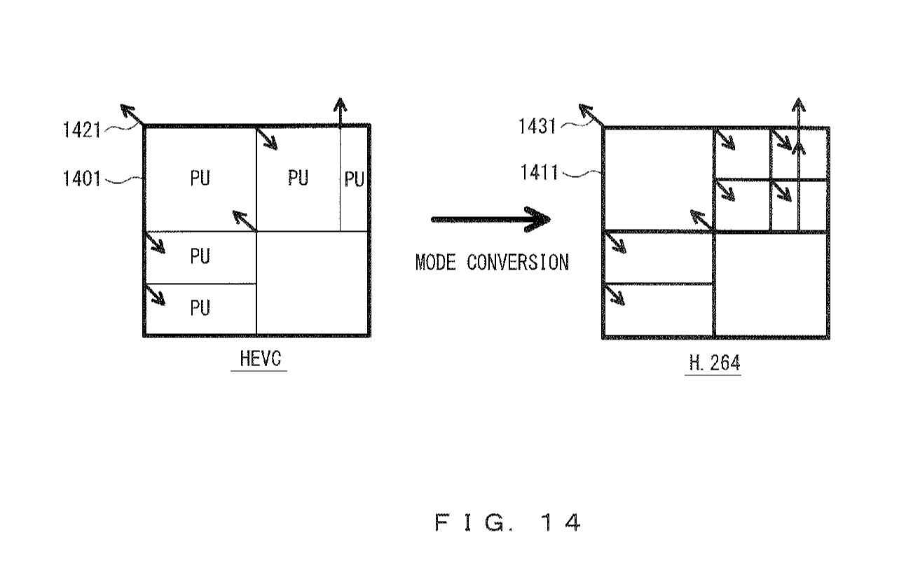

FIG. 14 illustrates an example of mode conversion processing performed by the mode converter 1113. Depending on the shape of each of the PUs in a CTU 1401 according to HEVC, each of the PUs is diverted into an MB 1411 according to H.264, or is divided into a plurality of MBs 1411. A motion vector 1431 of each of the MBs is determined according to a motion vector 1421 of each of the PUs.

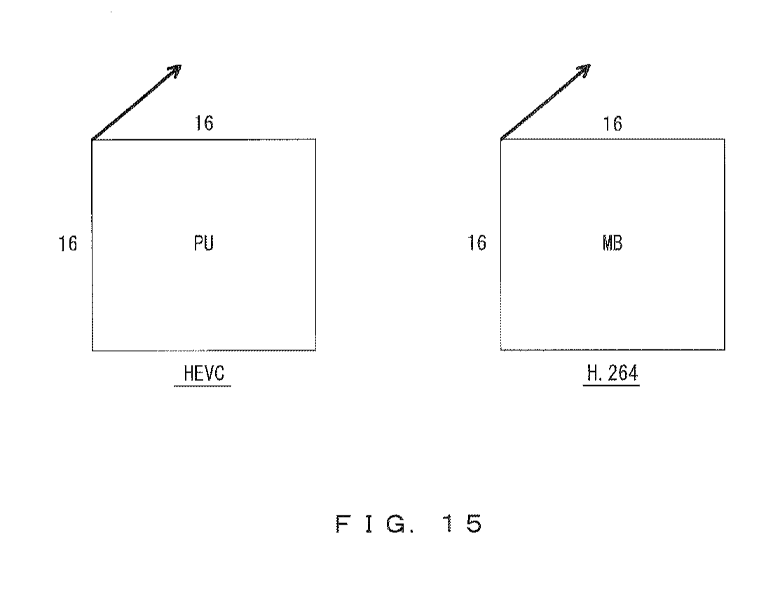

FIGS. 15 to 20 illustrate examples of a correspondence relationship between a PU and an MB. A method for converting the shape of a block is described with reference to FIGS. 15 to 20.

(A) A case in which a PU according to HEVC can be diverted into an MB according to H.264

As an example, in a case in which a PU is 16×16, as illustrated in FIG. 15, the mode converter 1113 diverts the PU into a 16×16 MB, and diverts a motion vector of the PU into a motion vector of the MB.

(B) A case in which a PU according to HEVC is larger than an MB according to H.264

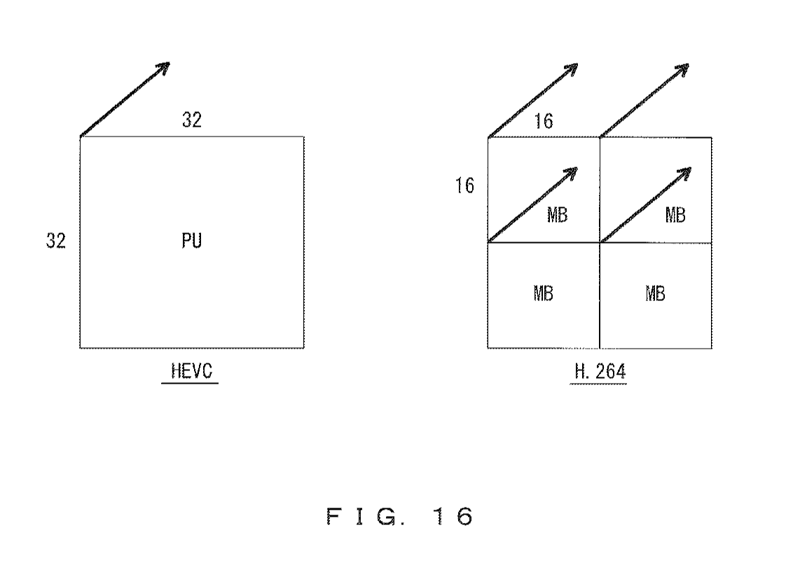

In this case, the mode converter 1113 divides the PU into a plurality of MBs, and gives the same motion vector to each of the MBs. As an example, in a case in which a PU is 32×32, as illustrated in FIG. 16, the mode converter 1113 divides the PU into four 16×16 MBs, and diverts a motion vector of the PU into a motion vector of each of the MBs.

(C) A case in which a PU according to HEVC is 8×4 or 4×8

A different reference image can be set for each of the PUs that are 8×4 or 4×8 according to HEVC, but it is not allowed to set a different reference image for each of the SubMBs according to H.264.

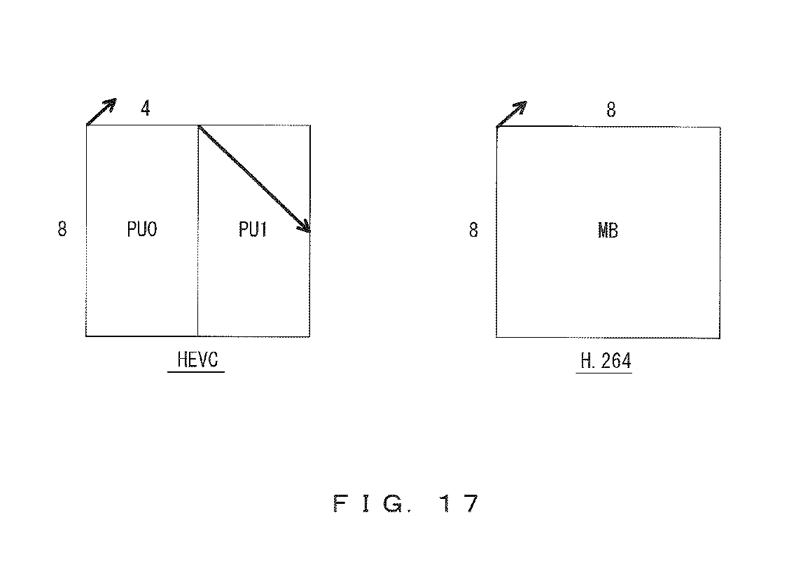

Accordingly, in a case in which different reference images are referred to for 4×8 PU0 and 4×8 PU1, respectively, as illustrated in FIG. 17, the mode converter 1113 compares encoding errors of the respective PUs with each other, and adopts a reference image for a PU having a smaller error and a motion vector of the PU. In this example, the mode converter 1113 integrates PU0 and PU1 so as to generate an 8×8 MB, and diverts a motion vector of PU0 into a motion vector of the MB.

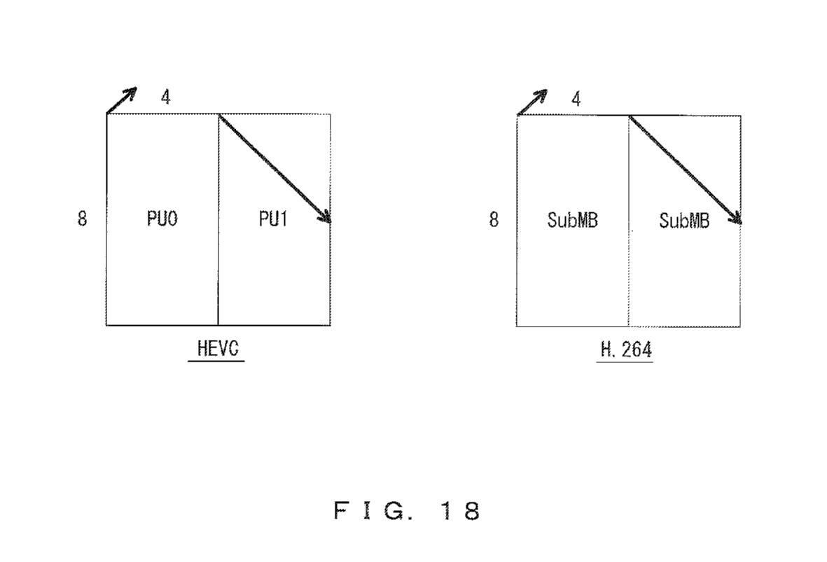

On the other hand, in a case in which the same reference image is referred to for PU0 and PU1, as illustrated in FIG. 18, the mode converter 1113 diverts PU0 and PU1 into two SubMBs, and diverts motion vectors of PU0 and PU1 into motion vectors of these SubMBs.

(D) A case in which a PU according to HEVC has an asymmetric shape and a boundary between PUs exists in an MB

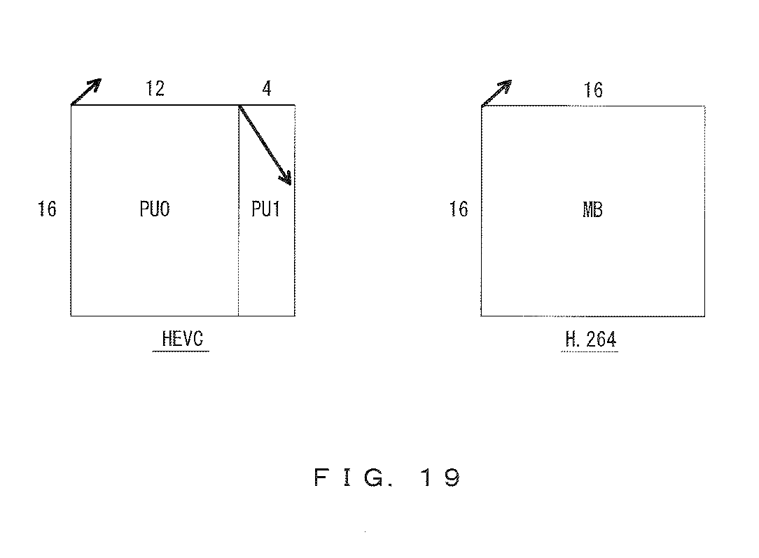

In a case in which a PU is 16×4, 16×12, 4×16, or 12×16, the shapes of the PU is asymmetric. As an example, assume a case in which PU0 is 12×16 and PU1 is 4×16, and different reference images are referred to for PU0 and PU1, respectively, as illustrated in FIG. 19. In this case, the mode converter 1113 compares encoding errors of the respective PUs with each other, and adopts a reference image for a PU having a smaller error and a motion vector of the PU. In this example, the mode converter 1113 integrates PU0 and PU1 so as to generate a 16×16 MB, and diverts a motion vector of PU0 into a motion vector of the MB.

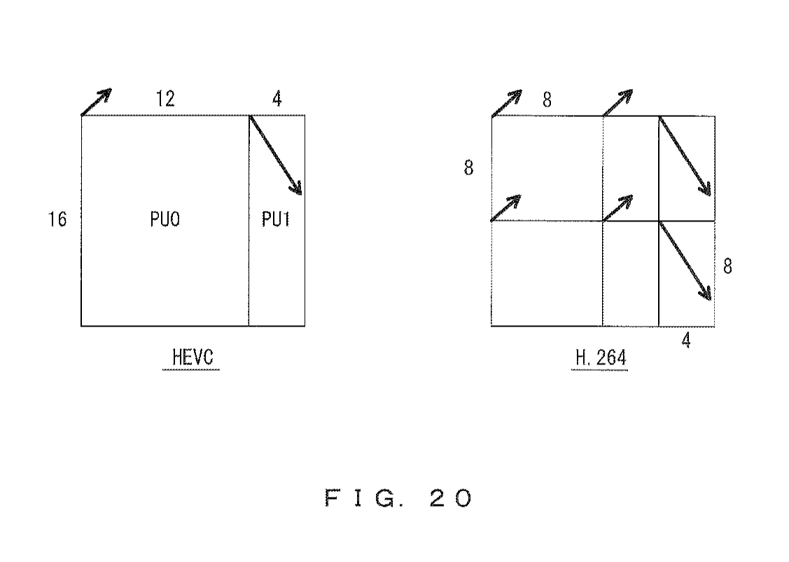

On the other hand, in a case in which the same reference image is referred to for PU0 and PU1, as illustrated in FIG. 20, the mode converter 1113 divides the PUs into four 8×8 MBs. In a case in which a boundary between the PUs exists in an MB, the mode converter 1113 further divides the MB into two 4×8 SubMBs. The mode converter 1113 diverts a motion vector of PU0 into motion vectors of two 8×8 MBs and two 4×8 SubMBs, and diverts a motion vector of PU1 into motion vectors of the remaining two 4×8 SubMBs. Consequently, the boundary between the PUs is used as a boundary between SubMBs with no change.

All of the correspondence relationships between a PU and an MB, including the correspondence relationships illustrated in FIGS. 15 to 20, are collected below.

(1) A case in which a PU is 64×64

Similarly to (B), the PU is converted into sixteen 16×16 MBs.

(2) A case in which a PU is 32×32

Similarly to (B), the PU is converted into four 16×16 MBs.

(3) A case in which a PU is 32×16

Similarly to (B), the PU is converted into two 16×16 MBs.

(4) A case in which a PU is 16×32

Similarly to (B), the PU is converted into two 16×16 MBs.

(5) A case in which a PU is 32×24

Similarly to (B), the PU is converted into four 16×16 MBs. In a case in which a boundary of the PU exists in a 16×16 MB, the MB is changed to a 16×8 MB.

(6) A case in which a PU is 32×8

Similarly to (B), the PU is converted into two 16×16 MBs. A boundary of the PU exists in the 16×16 MBs, and therefore each of the MBs is changed to a 16×8 MB.

(7) A case in which a PU is 24×32

Similarly to (B), the PU is converted into four 16×16 MBs. In a case in which a boundary of the PU exists in a 16×16 MB, the MB is changed to an 8×16 MB.

(8) A case in which a PU is 8×32

Similarly to (B), the PU is converted into two 16×16 MBs. A boundary of the PU exists in the 16×16 MBs, and therefore each of the MBs is changed to an 8×16 MB.

(9) A case in which a PU is 16×16

Similarly to (A), the PU is converted into a 16×16 MB.

(10) A case in which a PU is 16×8

Similarly to (A), the PU is converted into a 16×8 MB.

(11) A case in which a PU is 8×16

Similarly to (A), the PU is converted into an 8×16 MB.

(12) A case in which a PU is 8×8

Similarly to (A), the PU is converted into an 8×8 MB.

(13) A case in which a PU is 8×4

Similarly to (C), the PU is converted into an 8×8 MB or an 8×4 SubMB. In a case in which different reference images are referred to for two PUs, the 8×8 MB is adopted, and a reference image for a PU having a smaller error and a motion vector of the PU are adopted.

(14) A case in which a PU is 4×8

Similarly to (C), the PU is converted into an 8×8 MB or a 4×8 SubMB. In a case in which different reference images are referred to for two PUs, the 8×8 MB is adopted, and a reference image for a PU having a smaller error and a motion vector of the PU are adopted.

(15) A case in which a PU is 16×4

Similarly to (D), the PU is converted into a 16×16 MB, an 8×8 MB, or an 8×4 SubMB. In a case in which different reference images are referred to for two PUs, the 16×16 MB is adopted, and a reference image for a PU having a smaller error and a motion vector of the PU are adopted.

(16) A case in which a PU is 16×12

Similarly to (D), the PU is converted into a 16×16 MB, an 8×8 MB, or an 8×4 SubMB. In a case in which different reference images are referred to for two PUs, the 16×16 MB is adopted, and a reference image for a PU having a smaller error and a motion vector of the PU are adopted.

(17) A case in which a PU is 4×16

Similarly to (D), the PU is converted into a 16×16 MB, an 8×8 MB, or a 4×8 SubMB. In a case in which different reference images are referred to for two PUs, the 16×16 MB is adopted, and a reference image for a PU having a smaller error and a motion vector of the PU are adopted.

(18) A case in which a PU is 12×16

Similarly to (D), the PU is converted into a 16×16 MB, an 8×8 MB, or a 4×8 SubMB. In a case in which different reference images are referred to for two PUs, the 16×16 MB is adopted, and a reference image for a PU having a smaller error and a motion vector of the PU are adopted.

Then, the mode determination circuit 1131 determines a prediction mode of H.264 (step 1203). At this time, the mode determination circuit 1131 does not perform inter-prediction, and uses mode information of inter-prediction according to H.264 that has been received from the mode converter 1113.

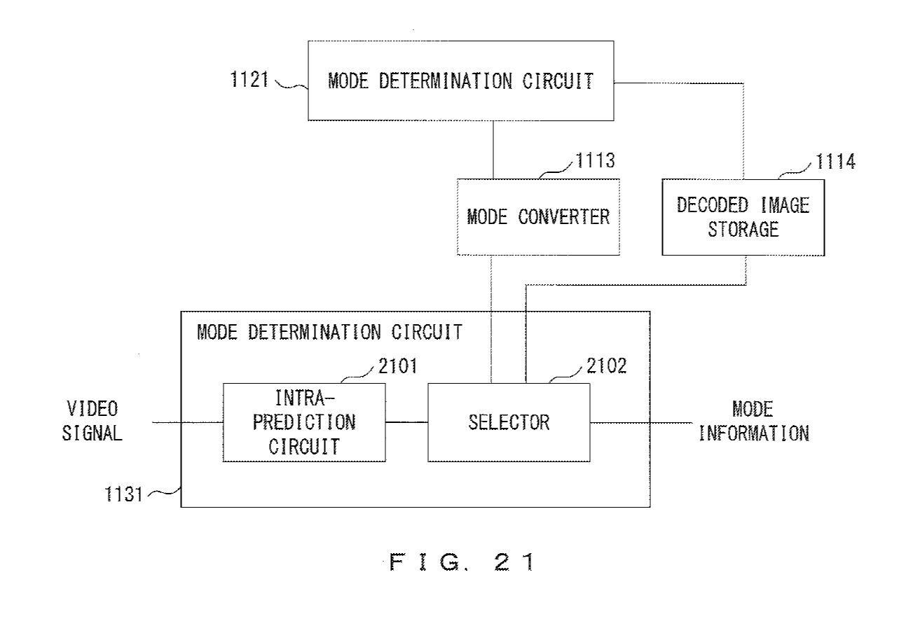

FIG. 21 illustrates an exemplary configuration of the mode determination circuit 1131. A mode determination circuit 1131 of FIG. 21 includes an intra-prediction circuit 2101 and a selector 2102. The intra-prediction circuit 2101 generates an intra-prediction block image from a pixel value of a peripheral pixel of a block to be encoded. The selector 2102 generates a prediction error signal indicating a difference between the block to be encoded and the intra-prediction block image.

The selector 2102 reads a decoded image from the decoded image storage 1114 in accordance with the mode information of inter-prediction according to H.264 that has been received from the mode converter 1113, and uses the read decoded image as an inter-prediction block image. The selector 2102 generates a prediction error signal indicating a difference between the block to be encoded and the inter-prediction block image.

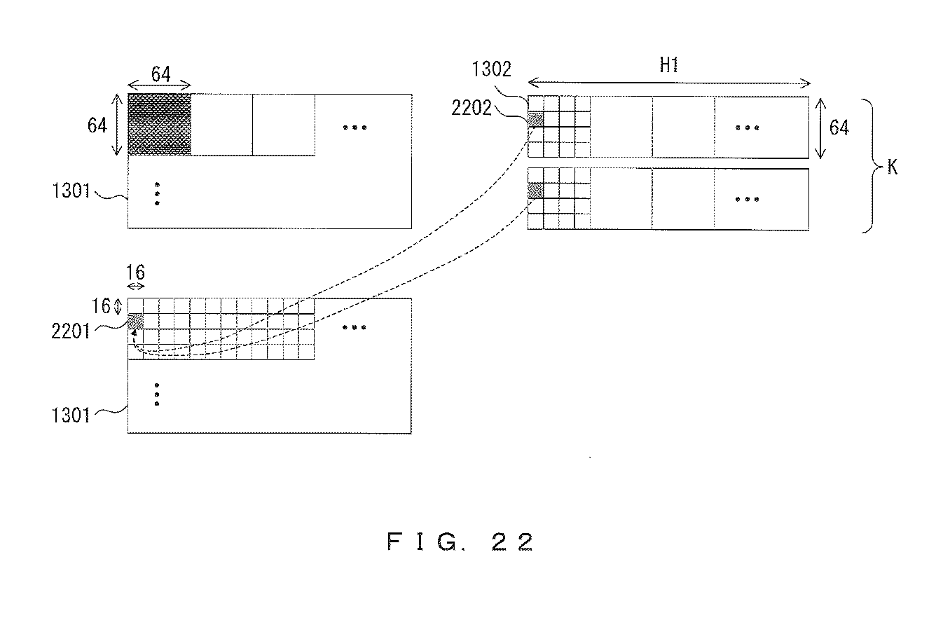

FIG. 22 illustrates an example of processing for reading a decoded image. The selector 2102 reads a decoded image 2202 in an area that is pointed at by a motion vector of an MB 2201 that is a block to be encoded in an image to be encoded 1301, from a decoded image area 1302 of a reference image indicated by mode information of the MB 2201. The selector 2102 generates a prediction error signal indicating a difference between the MB 2201 and the decoded image 2202.

The selector 2102 selects a prediction mode having a smaller encoding error from among intra-prediction and inter-prediction, generates H264 mode information of the block to be encoded, and outputs the H264 mode information to the encoder 1132.

Then, the encoder 1122 encodes the block to be encoded according to the HEVC mode information, and outputs an HEVC stream (step 1204). At this time, the encoder 1122 outputs the generated decoded image to the frame memory 1102.

The encoder 1132 encodes the block to be encoded according to the H264 mode information, and outputs an H264 stream (step 1205). The mode determination circuit 1131 does not need to refer to a decoded image according to H.264, and therefore the encoder 1132 does not output the generated decoded image to the frame memory 1102.

In the image encoding processing above, mode information of inter-prediction according to HEVC is diverted into inter-prediction according to H.264 in step 1202, and a decoded image is read from the decoded image storage 1114 in step 1203. Consequently, a decoded image does not need to be read from the frame memory 1102 in step 1203, and a decoded image does not need to be written to the frame memory 1102 in step 1205. A decoded image according to H.264 does not need to be stored, and therefore the capacity and a memory access band of the frame memory 1102 can be reduced by about 50%.

The image encoding device 1101 can use an encoding algorithm other than HEVC and H.264. In this case, the mode converter 1113 converts mode information of inter-prediction according to the encoding algorithm in step 1202.

Meanwhile, in the image encoding device 1101, the capacity of the frame memory 1102 is reduced by diverting a decoded image according to HEVC into a decoded image according to H.264. In this method, in a case in which a video signal is encoded simultaneously according to HEVC and H.264, it is assumed that decoded images used according to two types of encoding algorithms are almost the same as each other.

However, in a case in which a significant difference is generated between decoded images depending on encoding conditions of HEVC and H.264, a difference is generated between a decoded image according to H.264 and an H264 stream into which a decoded image according to HEVC is diverted. Therefore, the image quality of a video obtained by decoding the H264 stream may deteriorate.

Accordingly, a method is considered for storing a difference image indicating a difference between a decoded image according to HEVC and a decoded image according to H.264 and generating the decoded image according to H.264 from the decoded image according to HEVC by using the difference image. By using this method, the image quality of an H264 stream can be prevented from deteriorating.

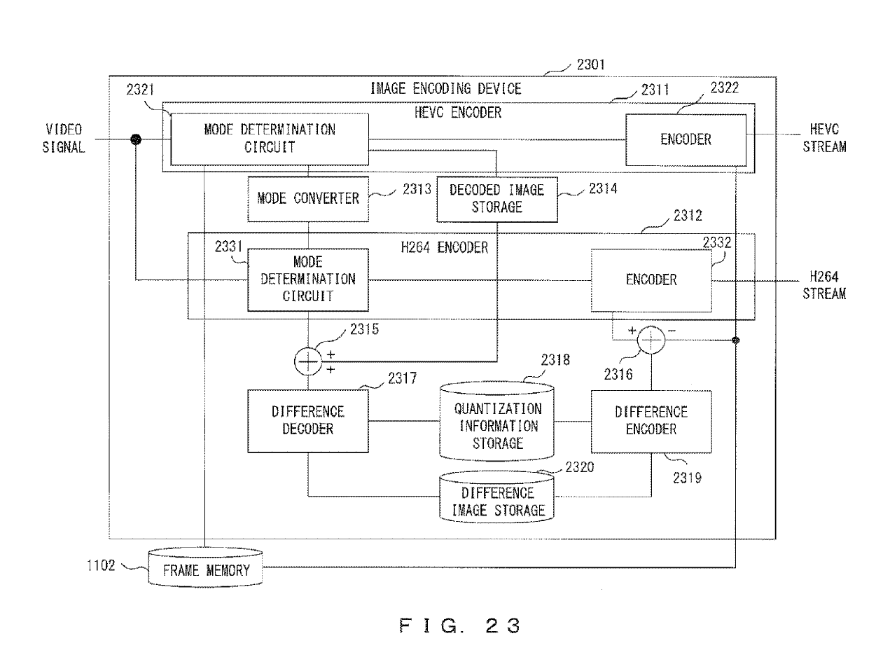

FIG. 23 illustrates a second specific example of the image encoding device 901 of FIG. 9 that uses the difference image above. An image encoding device 2301 of FIG. 23 includes an HEVC encoder 2311, an H264 encoder 2312, a mode converter 2313, and a decoded image storage 2314. The image encoding device 2301 further includes an adder 2315, a subtracter 2316, a difference decoder 2317, a quantization information storage 2318, a difference encoder 2319, and a difference image storage 2320. The HEVC encoder 2311 includes a mode determination circuit 2321 and an encoder 2322, and the H264 encoder 2312 includes a mode determination circuit 2331 and an encoder 2332.

Respective components of the image encoding device 2301 can be implemented, for example, as hardware circuits.

The HEVC encoder 2311, the H264 encoder 2312, the mode converter 2313, and the decoded image storage 2314 respectively correspond to the encoder 911, the encoder 912, the converter 913, and the decoded image storage 914 of FIG. 9.

The operations of the mode determination circuit 2321, the encoder 2322, the mode determination circuit 2331, and the encoder 2332 are similar to the operations of the mode determination circuit 1121, the encoder 1122, the mode determination circuit 1131, and the encoder 1132 of FIG. 11. The operations of the mode converter 2313 and the decoded image storage 2314 are similar to the operations of the mode converter 1113 and the decoded image storage 1114 of FIG. 11.

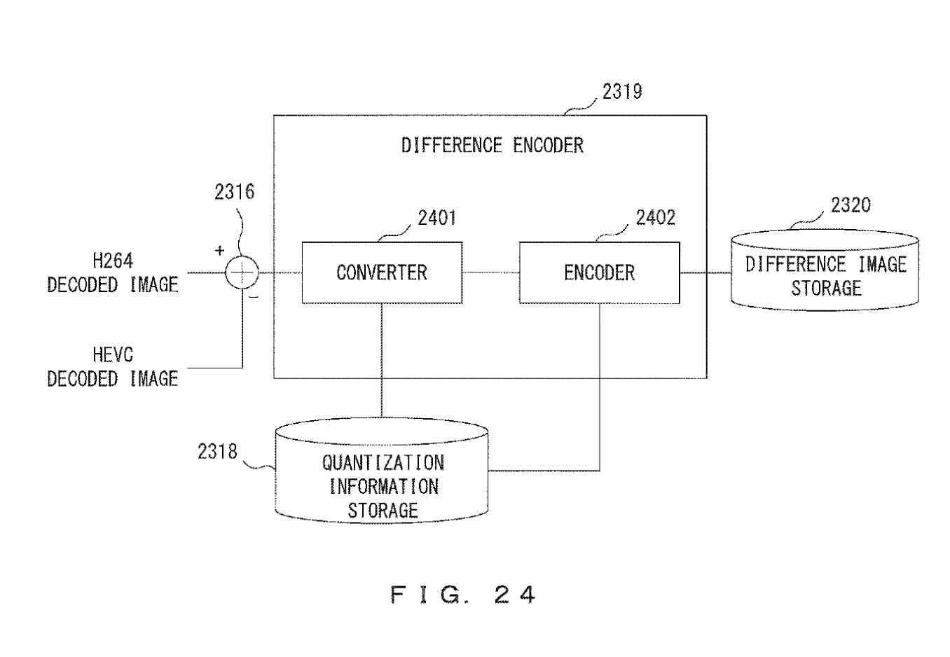

FIG. 24 illustrates an exemplary configuration of the difference encoder 2319 of FIG. 23. A difference encoder 2319 of FIG. 24 includes a converter 2401 and an encoder 2402. The subtracter 2316 subtracts an HEVC decoded image that is a decoded image generated by the encoder 2322 from an H264 decoded image that is a decoded image generated by the encoder 2332 so as to generate a difference image indicating a difference between the HEVC decoded image and the H264 decoded image.

The same video signal is input to the HEVC encoder 2311 and the H264 encoder 2312, and therefore an information amount of the difference image is expected to be small. However, the information amount is assumed to increase depending on a difference in an encoding condition between HEVC and H.264. Accordingly, the difference encoder 2319 performs frequency conversion, quantization, and encoding on the difference image so as to further compress the difference image.

The converter 2401 performs frequency conversion and quantization on the difference image so as to generate a compression coefficient, and outputs a quantization parameter used in quantization to the quantization information storage 2318. The quantization information storage 2318 stores the quantization parameter. The encoder 2402 encodes the compression coefficient generated by the converter 2401 so as to generate a difference code, and outputs the difference code to the difference image storage 2320. The difference image storage 2320 stores the difference code.

The converter 2401 can perform frequency conversion and quantization by using, for example, discrete cosine transformation (DCT) performed on an 8×8 area and linear quantization using a QP value as a step. The encoder 2402 can encode the compression coefficient by performing, for example, Huffman encoding. In this case, linear quantization, Huffman encoding, and writing to the difference image storage 2320 are performed in the units of 8×8 areas, similarly to DCT, and the quantization information storage 2318 stores the QP value used in linear quantization as a quantization parameter.

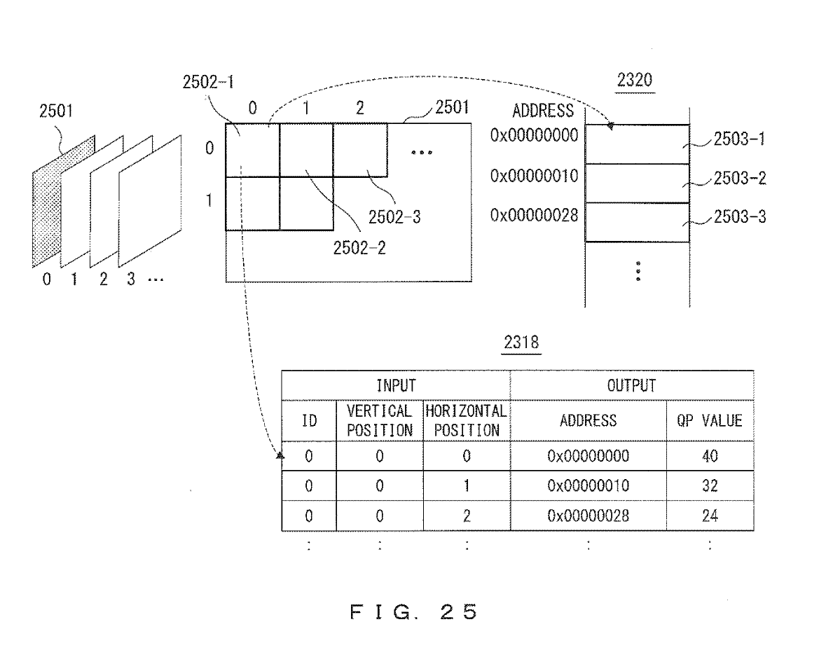

FIG. 25 illustrates examples of the quantization information storage 2318 and the difference image storage 2320. From among a plurality of images included in a video, an image to be encoded 2501 is divided into 8×8 areas, a difference code is generated for each of the areas, and the difference codes are written to the difference image storage 2320 in the raster order from an upper-left area of the image to be encoded 2501. As an example, difference codes of areas 2502-1 to 2502-3 are respectively written to areas 2503-1 to 2503-3 in the difference image storage 2320.

The converter 2401 outputs the QP value used in linear quantization in each of the areas to the quantization information storage 2318, and the encoder 2402 outputs, to the quantization information storage 2318, an address of an area to which the difference code is written within the difference image storage 2320.

The quantization information storage 2318 is, for example, a look-up table, and the quantization information storage 2318 includes the fields “INPUT” and “OUTPUT”. The field “INPUT” includes an ID, a vertical position, and a horizontal position, and the field “OUTPUT” includes an address and a QP value. The ID indicates identification information of the image to be encoded 2501, the vertical position indicates a position in the vertical direction of each of the areas within the image to be encoded 2501, and the horizontal position indicates a position in the horizontal direction of each of the areas within the image to be encoded 2501. The address is an address received from the encoder 2402, and the QP value is a QP value received from the converter 2401.

The quantization information storage 2318 stores the address and the QP value in association with a key that is uniquely determined according to the ID, the vertical position, and the horizontal position. As an example, an ID, a vertical position, and a horizontal position of the area 2502-2 are 0, 0, and 1, respectively, and an address and a QP value are 0x00000010 and 32, respectively.

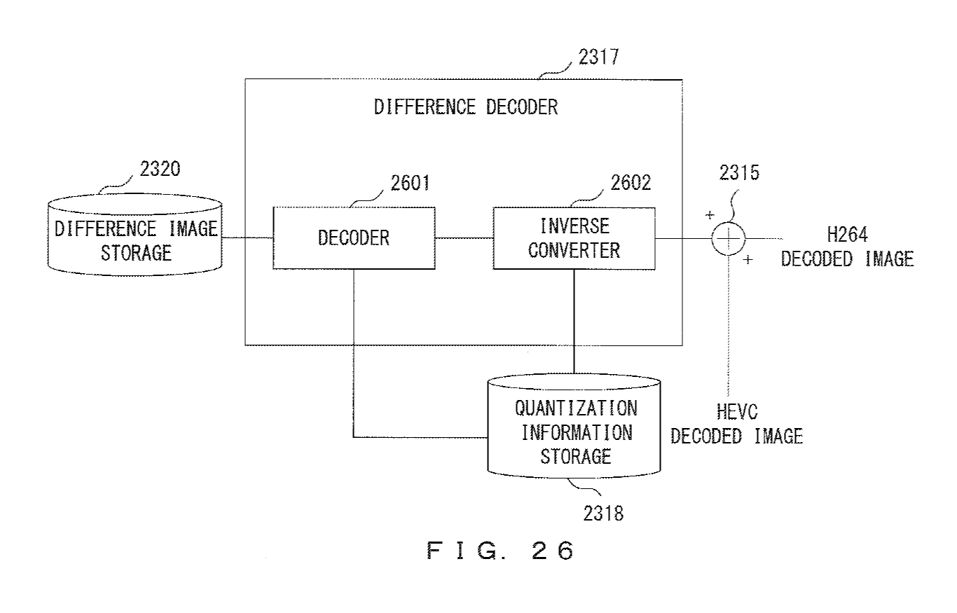

FIG. 26 illustrates an exemplary configuration of the difference decoder 2317 of FIG. 23. A difference decoder 2317 of FIG. 26 includes a decoder 2601 and an inverse converter 2602. The decoder 2601 reads an address from the quantization information storage 2318 by using an ID of a reference image requested by the mode determination circuit 2331, and a vertical position and a horizontal position of a reference area within the reference image as a key. The decoder 2601 calculates a difference between the address of the reference area and the address of the next area, and determines an amount of reading a difference code.

As an example, in a case in which the image to be encoded 2501 is used as a reference image and a reference area is the area 2502-2, a corresponding address is 0x00000010, and an address that corresponds to the next area 2502-3 is 0x00000028. Accordingly, the reading amount 0x00000018 is obtained by subtracting 0x00000010 from 0x00000028.

Then, the decoder 2601 reads a difference code that corresponds to the reading amount from an address within the difference image storage 2320 that corresponds to the reference area, and decodes the difference code so as to generate a compression coefficient.

The inverse converter 2602 reads a QP value from the quantization information storage 2318 by using an ID of the reference image, and a vertical position and a horizontal position of the reference area as a key. The inverse converter 2602 performs inverse quantization and inverse frequency conversion on the compression coefficient generated by the decoder 2601 by using the read QP value so as to generate a difference image. The adder 2315 adds the difference image to the HEVC decoded image read from the decoded image storage 2314 so as to generate an H264 decoded image, and outputs the H264 decoded image to the mode determination circuit 2331.

In a case in which a reference area requested by the mode determination circuit 2331 extends over a boundary between 8×8 areas, the decoder 2601 reads and decodes difference codes in a plurality of areas within a range including the reference area. The inverse converter 2602 performs inverse quantization and inverse frequency conversion on compression coefficients of the areas, and extracts a portion that corresponds to the reference area from a conversion result so as to generate a difference image.

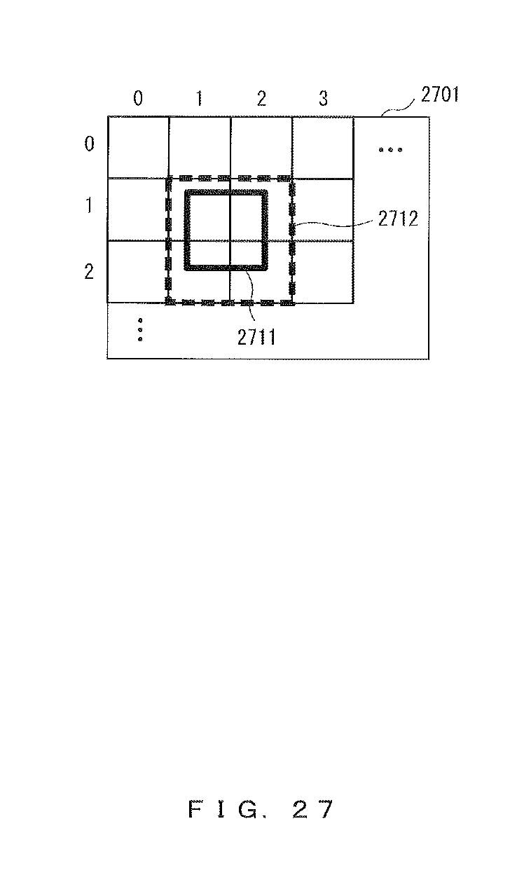

FIG. 27 illustrates an example of a reference area that extends over a plurality of areas. In a case in which a reference area 2711 within a reference image 2701 is requested by the mode determination circuit 2331, difference codes of four areas within a range 2712 including the reference area 2711 are read from the difference image storage 2320. An H264 decoded image of the reference area 2711 is generated by using the difference codes of these areas.

By employing the image encoding device 2301 of FIG. 23, the capacity of the difference image storage 2320 can be suppressed from increasing by generating a difference image indicating a difference between an HEVC decoded image and an H264 decoded image. In addition, the capacity of the difference image storage 2320 can be further reduced by compressing the difference image, writing the difference image to the difference image storage 2320, and performing inverse quantization on a difference code read from the difference image storage 2320 by using a quantization parameter in compression.

Consequently, the memory capacity for storing an H264 decoded image and a memory access band of the frame memory 1102 can be reduced similarly to the image encoding device 1101 of FIG. 11, and the image quality of an H264 stream can be prevented from deteriorating. In this case, the memory access bands of the difference image storage 2320 and the frame memory 1102 are reduced by at most 50% in total.

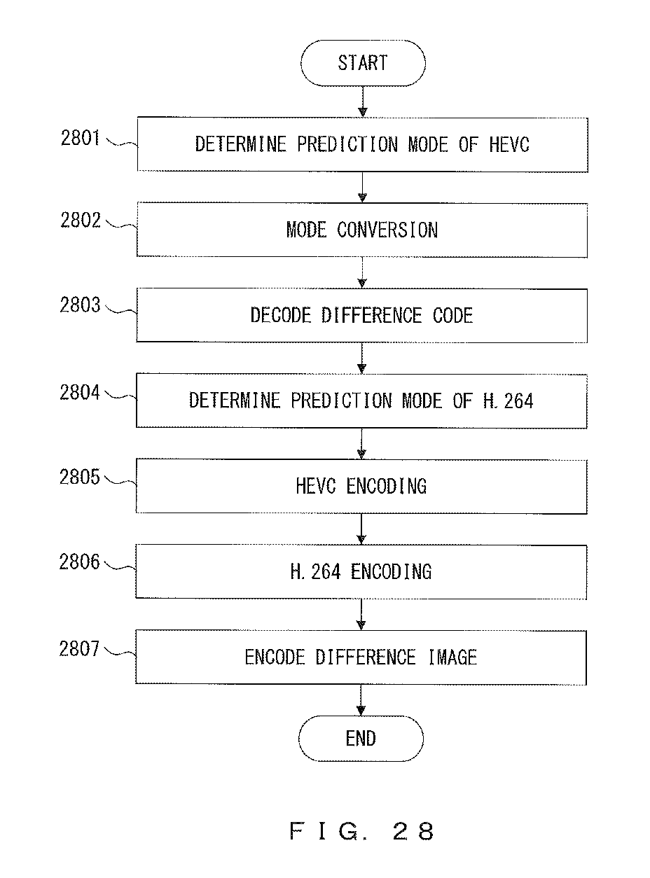

FIG. 28 is a flowchart illustrating a second specific example of image encoding processing performed by the image encoding device 2301 of FIG. 23. The processes of steps 2801, 2802, and 2804 to 2806 in FIG. 28 are similar to the processes of steps 1201 to 1205 of FIG. 12.

In step 2803, the mode determination circuit 2331 outputs, to the difference decoder 2317, an ID of a reference image, and a vertical position and a horizontal position of a reference area within the reference image in accordance with mode information of inter-prediction according to H.264 that has been received from the mode converter 1113. The difference decoder 2317 decodes a difference code that corresponds to the ID, the vertical position, and the horizontal position that have been received from the mode determination circuit 2331 so as to generate a difference image. The adder 2315 adds the difference image to an HEVC decoded image so as to generate an H264 decoded image, and outputs the generated H264 decoded image as a reference image to the mode determination circuit 2331.

In step 2807, the subtracter 2316 subtracts the HEVC decoded image from the H264 decoded image so as to generate a difference image. The difference encoder 2319 encodes the difference image so as to generate a difference code, and outputs the generated difference code to the difference image storage 2320.

The encoder 2322 in the HEVC encoder 2311 can be used instead of the difference decoder 2317 and the difference encoder 2319 of FIG. 23. In this case, a selector that selects one operation mode of HEVC encoding, difference image encoding, and difference code decoding is provided in the encoder 2322 such that a difference image can be encoded, and a difference code can be decoded by using a circuit of the encoder 2322.

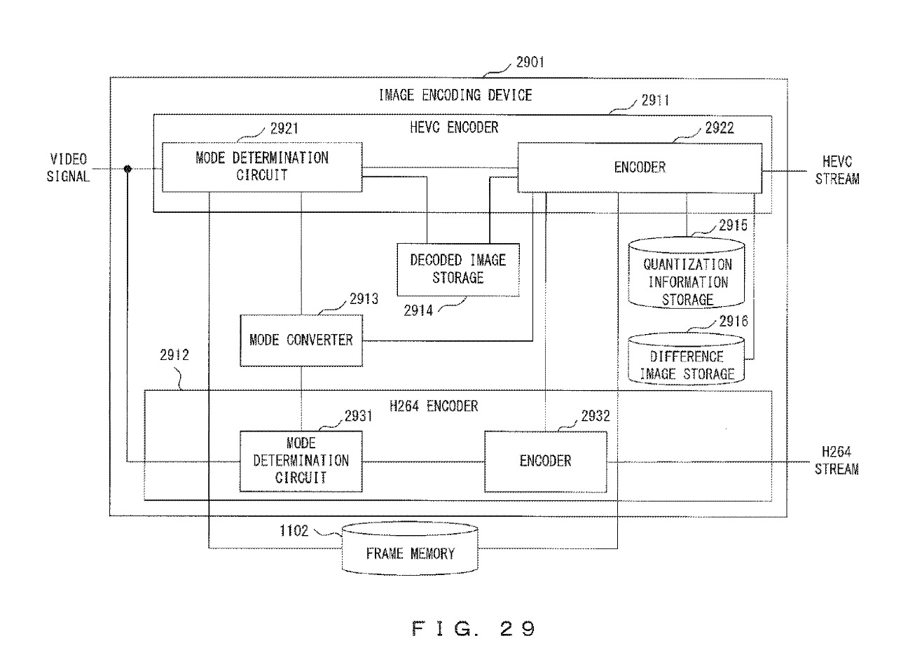

FIG. 29 illustrates a third specific example of the image encoding device 901 of FIG. 9 that shares a circuit in an HEVC encoder. An image encoding device 2901 of FIG. 29 includes an HEVC encoder 2911, an H264 encoder 2912, a mode converter 2913, a decoded image storage 2914, a quantization information storage 2915, and a difference image storage 2916. The HEVC encoder 2911 includes a mode determination circuit 2921 and an encoder 2922, and the H264 encoder 2912 includes a mode determination circuit 2931 and an encoder 2932.

Respective components of the image encoding device 2901 can be implemented, for example, as hardware circuits.

The HEVC encoder 2911, the H264 encoder 2912, the mode converter 2913, and the decoded image storage 2914 respectively correspond to the encoder 911, the encoder 912, the converter 913, and the decoded image storage 914 of FIG. 9.

The operations of the mode determination circuit 2921, the mode determination circuit 2931, and the encoder 2932 are similar to the operations of the mode determination circuit 2321, the mode determination circuit 2331, and the encoder 2332 of FIG. 23. The operations of the mode converter 2913, the decoded image storage 2914, the quantization information storage 2915, and the difference image storage 2916 are similar to the operations of the mode converter 2313, the decoded image storage 2314, the quantization information storage 2318, and the difference image storage 2320 of FIG. 23.

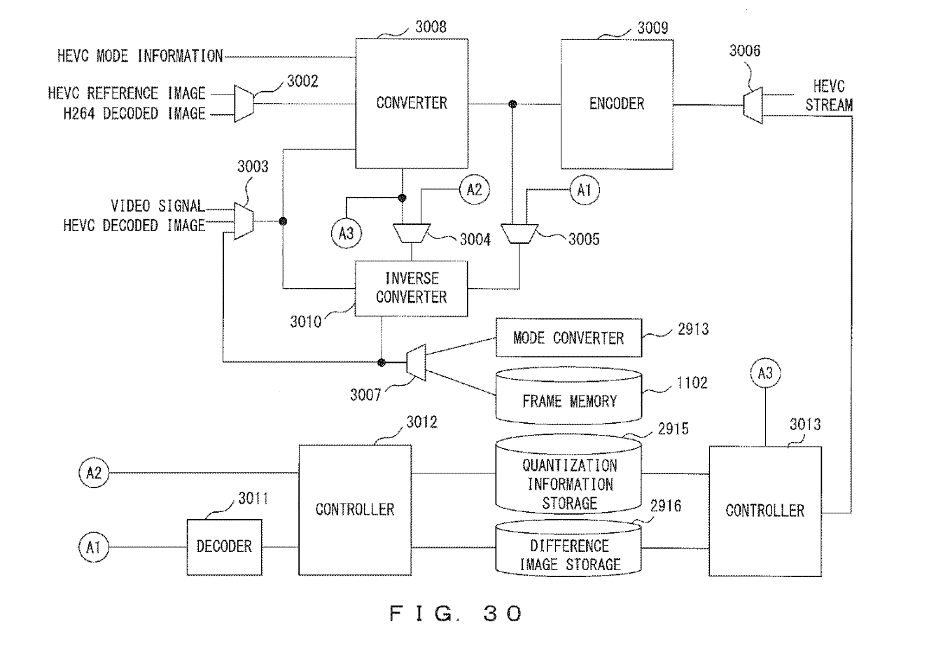

FIG. 30 illustrates an exemplary configuration of the encoder 2922 of FIG. 29. An encoder 2922 of FIG. 30 includes selectors 3002 to 3007, a converter 3008, an encoder 3009, an inverse converter 3010, a decoder 3011, a controller 3012, and a controller 3013. The mode determination circuit 2921 outputs HEVC mode information, and also outputs an intra-prediction block image or an inter-prediction block image as an HEVC reference image.

The selector 3002 selects the HEVC reference image that is output from the mode determination circuit 2921 or an H264 decoded image that is output from the encoder 2932, and outputs the HEVC reference image or the H264 decoded image to the converter 3008. The selector 3003 selects a video signal, an HEVC decoded image that is output from the decoded image storage 2914, or a decoded image that is output from the inverse converter 3010, and outputs the video signal, the HEVC decoded image, or the decoded image to the converter 3008.

The converter 3008 generates an error signal indicating a difference between a signal that is output from the selector 3002 and a signal that is output from the selector 3003. The converter 3008 performs frequency conversion and quantization on the error signal so as to generate a compression coefficient, and outputs a QP value used in quantization to the selector 3004 and the controller 3013. The encoder 3009 encodes the compression coefficient so as to generate an encoded bit string. The selector 3006 outputs the encoded bit string generated by the encoder 3009 as an HEVC stream, or outputs the encoded bit string to the controller 3013.

The selector 3004 selects the QP value that is output from the converter 3008 or the QP value that is output from the controller 3012, and outputs the selected QP value to the inverse converter 3010. The selector 3005 selects the compression coefficient that is output from the converter 3008 or the compression coefficient that is output from the decoder 3011, and outputs the selected compression coefficient to the inverse converter 3010.

The inverse converter 3010 performs inverse quantization and inverse frequency conversion on the compression coefficient that is output from the selector 3005 by using the QP value that is output from the selector 3004, and generates a reconfigured error signal. The inverse converter 3010 adds the signal that is output from the selector 3003 and the reconfigured error signal so as to generate a decoded image, and outputs the decoded image to the selector 3003 and the selector 3007. The selector 3007 outputs the decoded image that is output from the inverse converter 3010 to the mode converter 2913 or the frame memory 1102.

The controller 3013 writes the encoded bit string that is output from the selector 3006 as a difference code to the difference image storage 2916, and writes the address of the written difference code and the QP value that is output from the converter 3008 to the quantization information storage 2915.

The controller 3012 reads the address and the QP value from the quantization information storage 2915, and reads the difference code from the difference image storage 2916 by using the read address. The controller 3012 outputs the read QP value to the selector 3004, and outputs the read difference code to the decoder 3011. The decoder 3011 decodes the difference code so as to generate a compression coefficient, and outputs the generated compression coefficient to the selector 3005.

The selectors 3002 to 3007, the controller 3012, and the controller 3013 operate in any operation mode of HEVC encoding, difference image encoding, and difference code decoding in accordance with an operation mode selection signal.

In HEVC encoding, the controller 3012 and the controller 3013 stop operating. The selector 3002 selects an HEVC reference image, and the selector 3003 selects a video signal. The selector 3004 selects the QP value that is output from the converter 3008, and selects the compression coefficient that is output from the converter 3008.

Consequently, the converter 3008 generates a prediction error signal indicating a difference between the HEVC reference image and the video signal in accordance with HEVC mode information, and generates a compression coefficient of HEVC from the prediction error signal. The selector 3006 outputs the encoded bit string generated by the encoder 3009 as an HEVC stream.

In addition, the inverse converter 3010 performs inverse quantization and inverse frequency conversion on the compression coefficient that is output from the converter 3008 by using the QP value that is output from the converter 3008, and generates a reconfigured prediction error signal. The inverse converter 3010 adds the video signal and the reconfigured prediction error signal so as to generate a decoded image, and outputs the decoded image to the selector 3003 and the selector 3007. The selector 3007 outputs the decoded image that is output from the inverse converter 3010 as an HEVC decoded image to the frame memory 1102.

In difference image encoding, the selector 3004, the selector 3005, and the controller 3012 stop operating. The selector 3002 selects the H264 decoded image, and the selector 3003 selects the decode image that is output from the inverse converter 3010.

Consequently, the converter 3008 generates an error signal indicating a difference between the H264 decoded image and the decoded image generated in HEVC encoding, and generates a compression coefficient of a difference image from the error signal. The converter 3008 outputs the QP value used in quantization to the controller 3013. The selector 3006 outputs the encoded bit string generated by the encoder 3009 to the controller 3013.

The controller 3013 writes the encoded bit string that is output from the selector 3006 as a difference code to the difference image storage 2916, and writes the address of the written difference code and the QP value that is output from the converter 3008 to the quantization information storage 2915.

In difference code decoding, the selector 3002 and the controller 3013 stop operating. The controller 3012 outputs, to the selector 3004, the QP value read from the quantization information storage 2915, and outputs, to the decoder 3011, the difference code read from the difference image storage 2916. The decoder 3011 outputs the compression coefficient generated from the difference code to the selector 3005.

The selector 3003 selects the HEVC decoded image that is output from the decoded image storage 2914, the selector 3004 selects the QP value that is output from the controller 3012, and the selector 3005 selects the compression coefficient that is output from the decoder 3011.

Consequently, the inverse converter 3010 performs inverse quantization and inverse frequency conversion on the compression coefficient that is output from the decoder 3011 by using the QP value that is output from the controller 3012, and generates a reconfigured error signal. The inverse converter 3010 adds the HEVC decoded image and the reconfigured error signal so as to generate a decoded image. The selector 3007 outputs the decoded image generated by the inverse converter 3010 as an H264 decoded image to the mode converter 2913. The mode converter 2913 outputs the received H264 decoded image to the mode determination circuit 2931.

By employing the image encoding device 2901 of FIG. 29, the encoder 2922 is shared in HEVC encoding, difference image encoding, and difference code decoding, and therefore the number of circuits to encode and decode a difference image can be suppressed from increasing.

In encoding a difference image by using the difference encoder 2319 of FIG. 23, when a compression ratio increases, an amount of access of a memory access to the difference image storage 2320 decreases. However, reproducibility of an H.264 decoded image is reduced due to missing of information relating to a difference image, and the image quality of an H264 stream deteriorates. When the compression ratio decreases, the image quality is suppressed from deteriorating, but an amount of access to the difference image storage 2320 increases. In a case in which an allowable value of a memory access band of the difference image storage 2320 is predetermined, it is preferable that the amount of access and the image quality be optimized within a range of the allowable value.

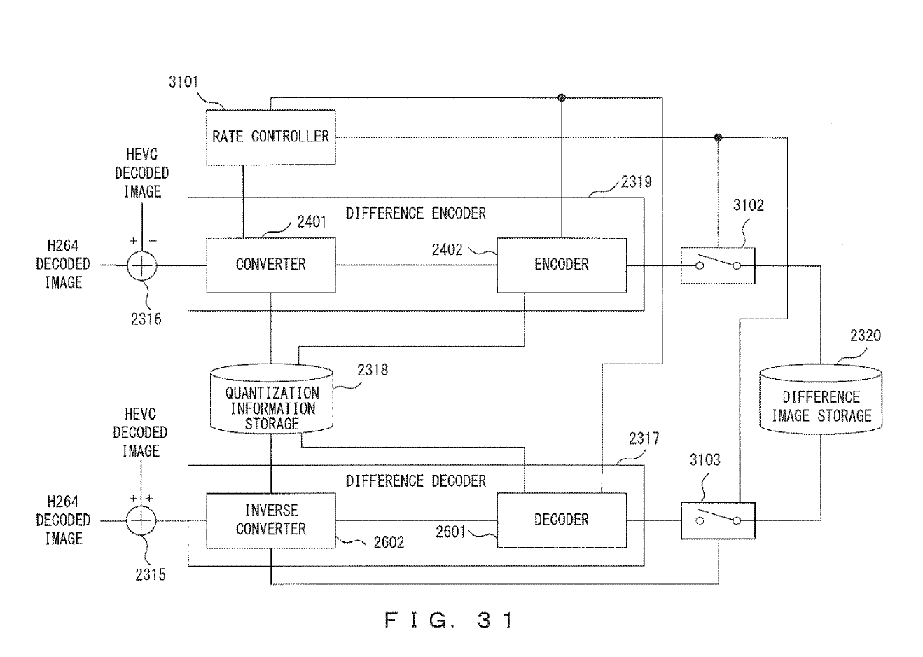

FIG. 31 illustrates an example of a rate controller that optimizes an amount of access and image quality. A rate controller 3101, a switch 3102, and a switch 3103 of FIG. 31 are provided in the image encoding device 2301 of FIG. 23.

The rate controller 3101, the switch 3102, and the switch 3103 can be implemented, for example, as hardware circuits.

The switch 3102 is provided between the difference encoder 2319 and the difference image storage 2320. When the switch 3102 is in the ON state, a writing operation in which the difference encoder 2319 writes a difference code to the difference image storage 2320 is allowed, and when the switch 3102 is in the OFF state, the writing operation is inhibited.

The switch 3103 is provided between the difference image storage 2320 and the difference decoder 2317. When the switch 3103 is in the ON state, a reading operation in which the difference decoder 2317 reads a difference code from the difference image storage 2320 is allowed, and when the switch 3103 is in the OFF state, the reading operation is inhibited.

The rate controller 3101 controls a compression ratio in encoding a difference image in accordance with a writing information amount generated in the writing operation, a reading information amount generated in the reading operation, and a target information amount. The encoder 2402 outputs, to the rate controller 3101, an accumulated generated-information amount generated in encoding of the difference image, and the decoder 2601 outputs, to the rate controller 3101, an accumulated generated-information amount generated in decoding of the difference code.

The rate controller 3101 compares the sum Ho of the accumulated generated-information amounts that are output from the encoder 2402 and the decoder 2601 with the target information amount Ht, and controls a QP value of the converter 2401 in such a way that Ho follows Ht. The rate controller 3101 can determine, for example, a QP value (QP) of an area to be converted that is a target for frequency conversion on the basis of a QP value (QP′) of a previously converted area in accordance with the following expressions.

QP=QP′−1 (Ho<Ht) (1)

QP=QP′ (Ho=Ht) (2)

QP=QP′+1 (Ho>Ht) (3)

An 8×8 area illustrated in FIG. 25 can be used, for example, as the area to be converted. In addition, an initial value QPinit of QP′ is set as an initial parameter.

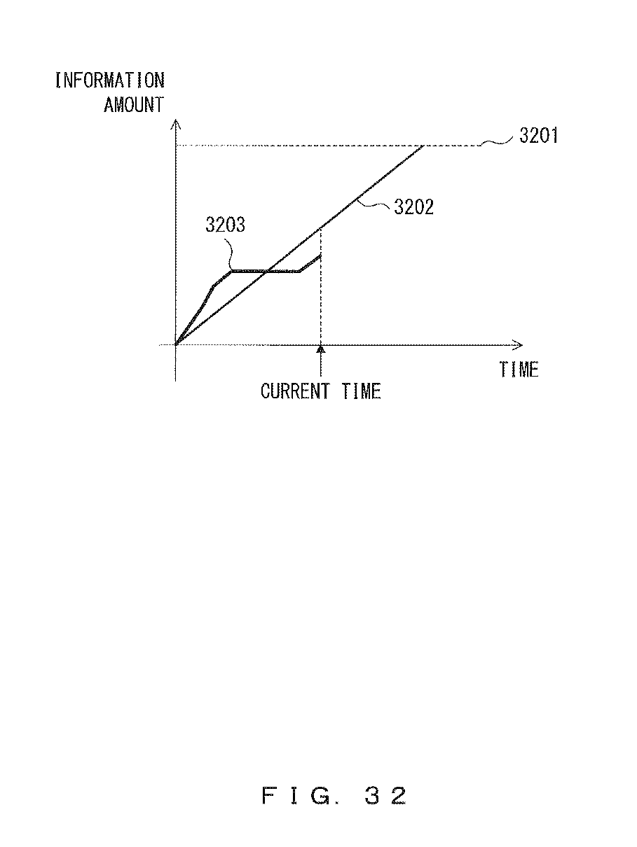

FIG. 32 illustrates an example of an accumulated generated-information amount. A straight line 3201 of FIG. 32 indicates an upper limit value of the target information amount Ht, a straight line 3202 indicates a temporal change in the target information amount Ht, and a polygonal line 3203 indicates a temporal change in the sum Ho of accumulated generated-information amounts.

The rate controller 3101 determines that there is a margin in a memory access band of the difference image storage 2320 because Ho is smaller than Ht at a current time, and the rate controller 3101 decrements the QP value by 1 so as to reduce the compression ratio. Consequently, a writing information amount of the difference code increases, and reproducibility of the H.264 decoded image is improved.

When Ho is greater than Ht at a current time, the rate controller 3101 determines that there is no margin in the memory access band of the difference image storage 2320, and the rate controller 3101 increments the QP value by 1 so as to increase the compression ratio. Consequently, the writing information amount of the difference code decreases, and an amount of access to the difference image storage 2320 is suppressed.

The rate controller 3101 can sip the writing operation when the writing information amount is smaller than a prescribed value. In this case, the encoder 2402 outputs a generated-information amount H generated in encoding an area to be converted to the rate controller 3101.

When the generated-information amount H is sufficiently small, it can be determined that an information amount of the difference image is small, namely, a difference between the HEVC decoded image and the H.264 decoded image is small. Accordingly, when the generated-information amount H is smaller than a prescribed value, the rate controller 3101 skips the writing operation by setting the switch 3102 in the OFF state. Consequently, the amount of access to the difference image storage 2320 is further reduced.

The rate controller 3101 can also skip the reading operation when the writing operation is skipped. In this case, the rate controller 3101 outputs, to the converter 2401, skip information indicating that the reading operation is skipped, and the converter 2401 outputs the skip information to the quantization information storage 2318.

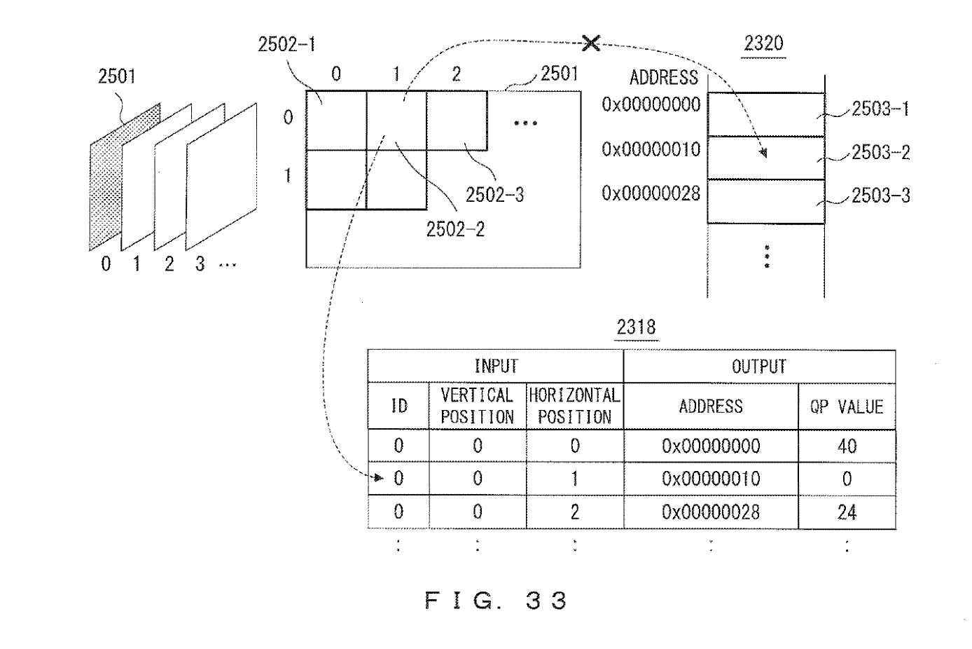

FIG. 33 illustrates an example of skip information. When a generated-information amount H for an area 2502-2 in an image to be encoded 2501 is smaller than a prescribed value, writing a difference code to an area 2502-2 in the difference image storage 2320 is skipped. The rate controller 3101 outputs the QP value “0” as skip information to the converter 2401, and the converter 2401 writes “0” as a QP value that corresponds to the area 2502-2 in the quantization information storage 2318.

When the QP value read from the quantization information storage 2318 is “0”, the inverse converter 2602 determines that the writing operation is skipped, and skips the reading operation performed on the difference image storage 2320 by setting the switch 3103 in the OFF state. The inverse converter 2602 outputs a signal indicating a difference of 0 to the adder 2315, and the adder 2315 outputs the HEVC decoded image as the H.264 decoded image with no change.

The rate controller 3101 can inhibit the writing operation and the reading operation when an accumulated value of the writing information amount and the reading information amount reaches an upper limit value. Consequently, memory access that exceeds an allowable value of an access amount can be prevented from being performed, when the generated-information amount is greater than expected.

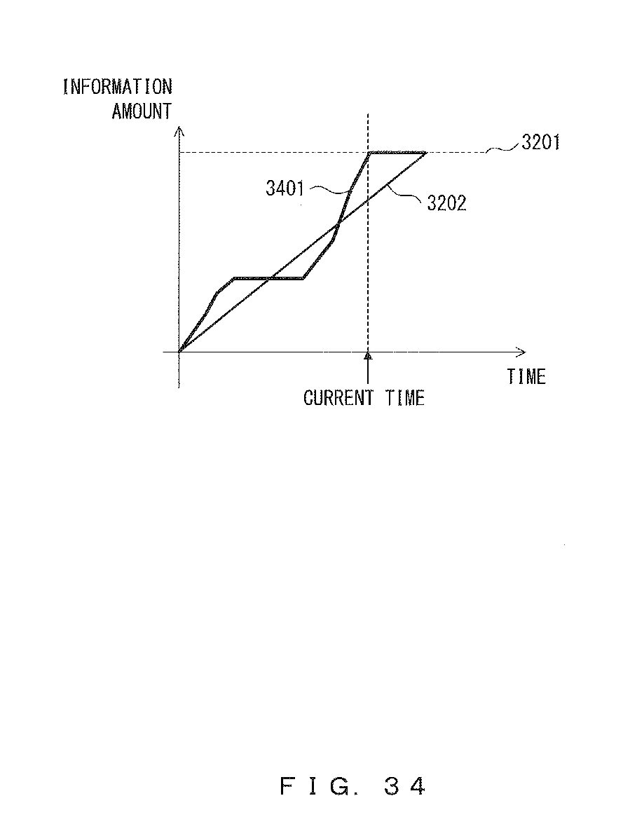

FIG. 34 illustrates an example of an accumulated generated-information amount that reaches an upper limit value. When the sum Ho of accumulated generated-information amounts indicated by a polygonal line 3401 reaches an upper limit value of the target information amount Ht indicated by a straight line 3201 at a current time, the rate controller 3101 sets the switch 3102 and the switch 3103 in the OFF state. Consequently, the writing operation and the reading operation are inhibited, and Ho is prevented from exceeding the upper limit value.

In this case, the inverse converter 2602 outputs a signal indicating a difference of 0 to the adder 2315, and the adder 2315 outputs the HEVC decoded image as the H.264 decoded image with no change.

Also in the image encoding device 2901 of FIG. 29, an access amount and image quality can be optimized by providing the rate controller 3101, the switch 3102, and the switch 3103 in the encoder 2922.

In the image encoding processing described above, mode information of inter-prediction according to HEVC is diverted into inter-prediction according to H.264. Similarly, mode information of intra-prediction according to HEVC can be diverted into intra-prediction according to H.264. In intra-prediction, an intra-prediction block image is generated from a pixel value of a peripheral pixel of a block to be encoded.

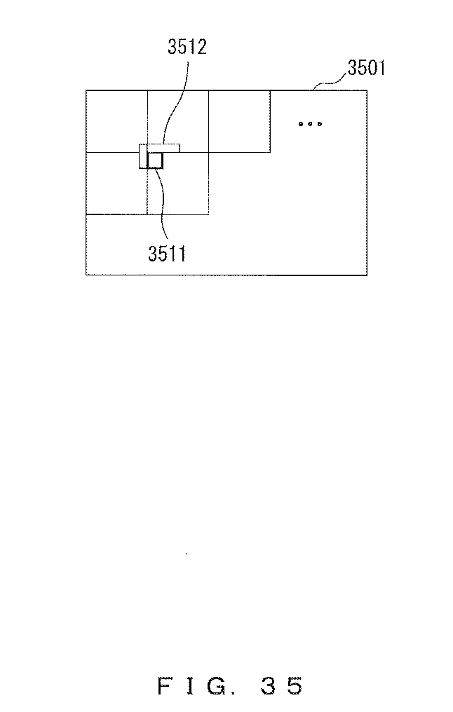

FIG. 35 illustrates an example of a peripheral pixel. In an image to be encoded 3501, peripheral blocks of a block to be encoded 3511 according to H.264 have already been encoded according to HEVC. Accordingly, pixel values of peripheral pixels 3512 of the block to be encoded 3511, that are included in a decoded image according to HEVC, can be diverted into intra-prediction according to H.264.

The operation of the image encoding device 1101 of FIG. 11 is described below. The same applies to the operations of the image encoding device 2301 of FIG. 23 and the image encoding device 2901 of FIG. 29.

The mode determination circuit 1121 outputs mode information of intra-prediction according to HEVC to the mode converter 1113, and also outputs a decoded image used in intra-prediction to the decoded image storage 1114. The mode converter 1113 converts the mode information of intra-prediction according to HEVC into mode information of intra-prediction according to H.264, and outputs the mode information of intra-prediction according to H.264 to the mode determination circuit 1131. The mode determination circuit 1131 reads the decoded image from the decoded image storage 1114 in accordance with the mode information of intra-prediction according to H.264 received from the mode converter 1113, and uses the read decoded image as an intra-prediction block image according to H.264.

The mode information of intra-prediction includes an intra-prediction mode, and the sizes of a luminance block and a color difference block. There is the following difference in mode information between HEVC and H.264.

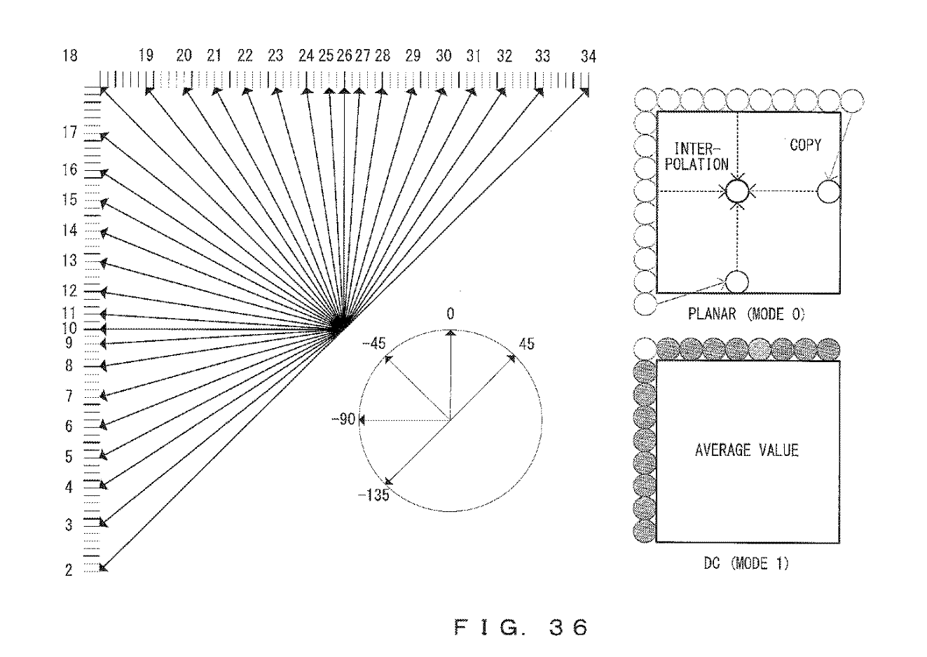

FIG. 36 illustrates examples of intra-prediction modes according to HEVC. In HEVC, 35 types in total of intra-prediction modes, planar prediction, DC prediction, and directional angular prediction (in 33 types of prediction directions), are used.

The shape of a PU has 5 types, 64×64, 32×32, 16×16, 8×8, and 4×4, in the case of the luminance block, and has 4 types, 32×32, 16×16, 8×8, and 4×4, in the case of the color difference block. For any shape, one intra-prediction mode is selected from 35 types of intra-prediction modes.

An intra-prediction mode according to H.264 varies depending on whether a block to be encoded is a luminance block or a color difference block. The shape of the luminance block used in intra-prediction has two types, 16×16 and 4×4.

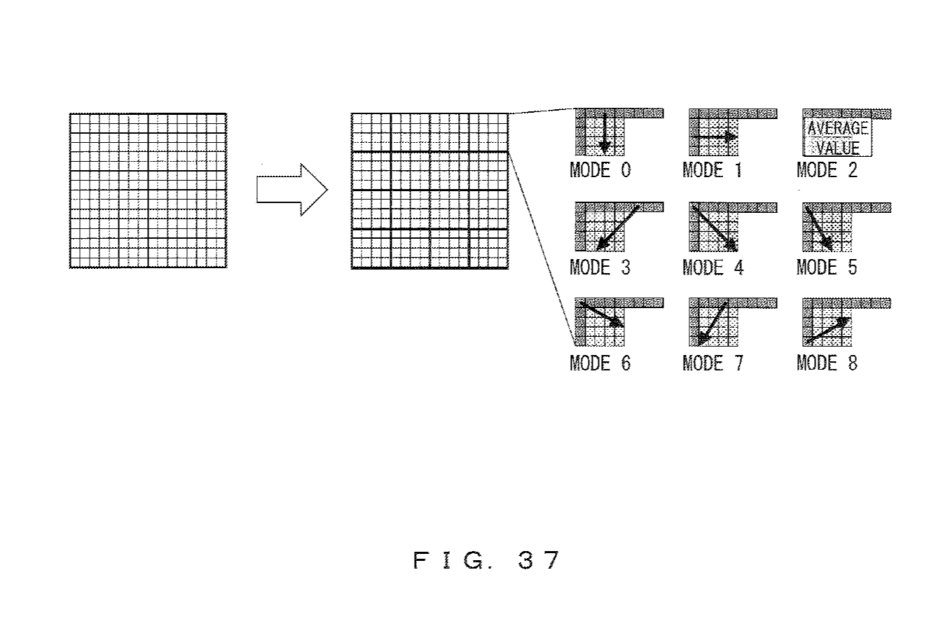

FIG. 37 illustrates examples of intra-prediction modes of a 4×4 luminance block according to H.264. In this case, a 16×16 MB is divided into sixteen 4×4 luminance blocks, and one intra-prediction mode is selected from 9 types of intra-prediction modes, modes 0 to 8, for each of the luminance blocks.

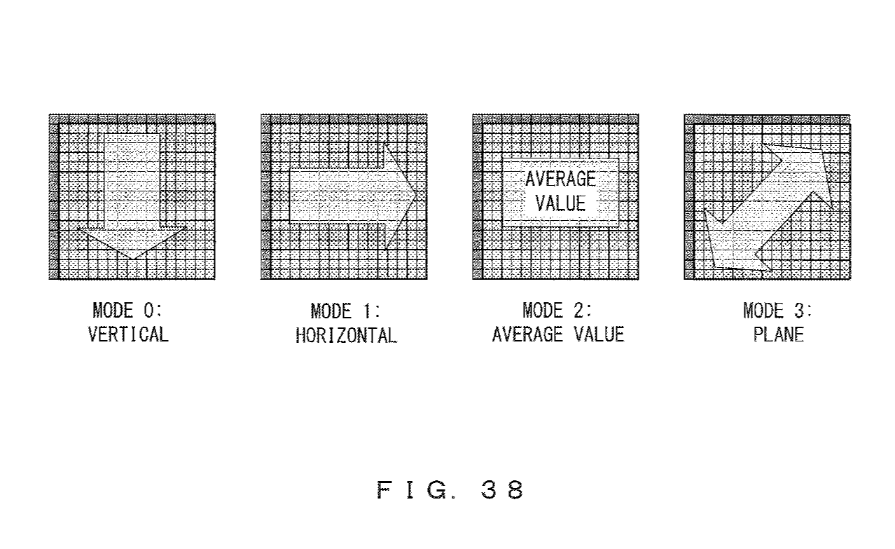

FIG. 38 illustrates examples of intra-prediction modes of a 16×16 luminance block according to H.264. In this case, one intra-prediction mode is selected from 4 types of intra-prediction modes, modes 0 to 3, for each of the 16×16 MBs.

On the other hand, the shape of a color difference block used in intra-prediction has 2 types, 8×8 and 4×4.

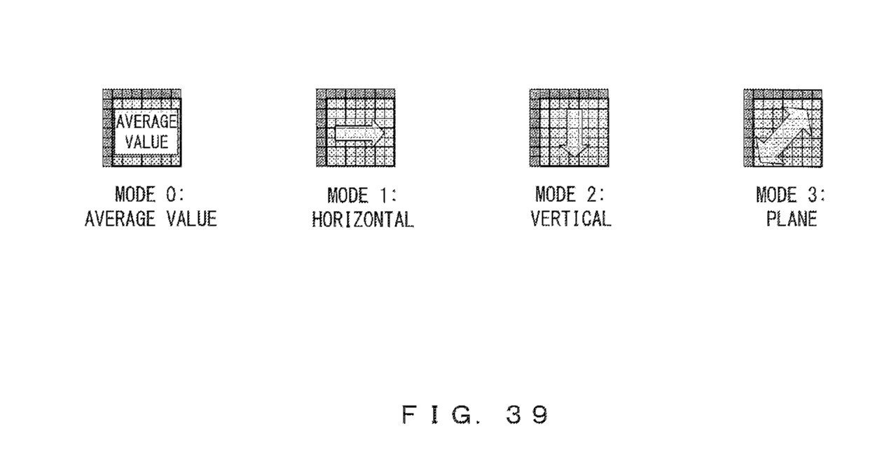

FIG. 39 illustrates examples of intra-prediction modes of an 8×8 color difference block according to H.264. In this case, one intra-prediction mode is selected from 4 types of intra-prediction modes, modes 0 to 3, for each of the 8×8 color difference blocks. Also in the case of a 4×4 color difference block, an intra-prediction mode is selected similarly to the case of the 8×8 color difference block.

On the assumption of the difference above in the intra-prediction mode between HEVC and H.264, the mode converter 1113 performs the following mode conversion processing in a case in which a block to be encoded is a luminance block.

(A) A case in which the size of a PU according to HEVC is greater than or equal to a maximum size (16×16) that is allowed according to H.264 and an intra-prediction mode is a horizontal direction (10) or a vertical prediction (26) of angular prediction, DC prediction, or planar prediction

In this case, the mode converter 1113 divides the PU into 16×16 MBs, and allocates the same intra-prediction mode to all of the MBs, as described below.

1. HEVC: the horizontal direction (10) of angular prediction→H.264: mode 1 (horizontal)

2. HEVC: the vertical direction (26) of angular prediction→H.264: mode 0 (vertical)

3. HEVC: DC prediction→H.264: mode 2 (average value)

4. HEVC: planar prediction→H.264: mode 3 (plane)

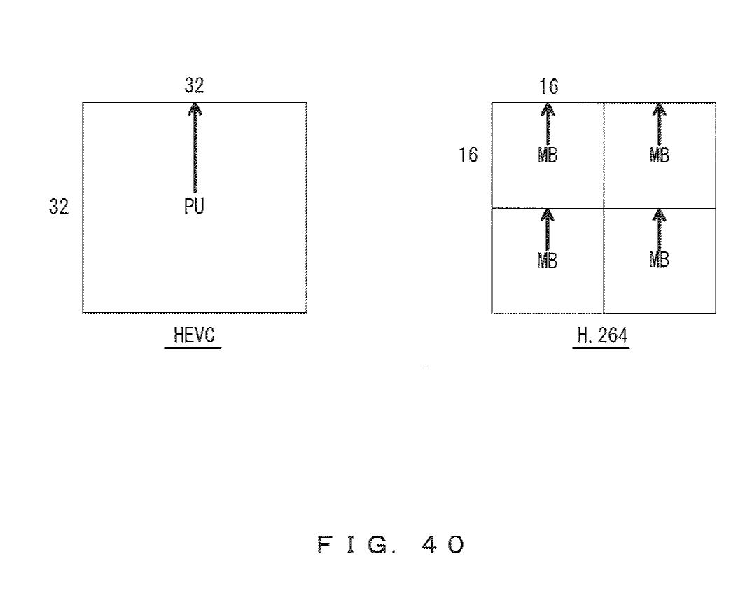

FIG. 40 illustrates an example of a correspondence relationship between a PU and an MB in a case in which the PU is 32×32. In a case in which an intra-prediction mode of HEVC is the vertical direction (26), the mode converter 1113 divides the PU into four 16×16 MBs, and allocates mode 0 (vertical) of H.264 to all of the MBs.

(B) A case in which the size of a PU according to HEVC is greater than or equal to a maximum size (16×16) that is allowed according to H.264 and an intra-prediction mode is not the horizontal direction (10) or the vertical direction (26) of angular prediction, DC prediction, or planar prediction

In this case, the mode converter 1113 divides the PU into 16×16 MBs, and further divides each of the MBs into 4×4 luminance blocks. The mode converter 1113 allocates a prediction direction according to H.264 that approximates a prediction direction of angular prediction according to HEVC to all of the 4×4 luminance blocks.

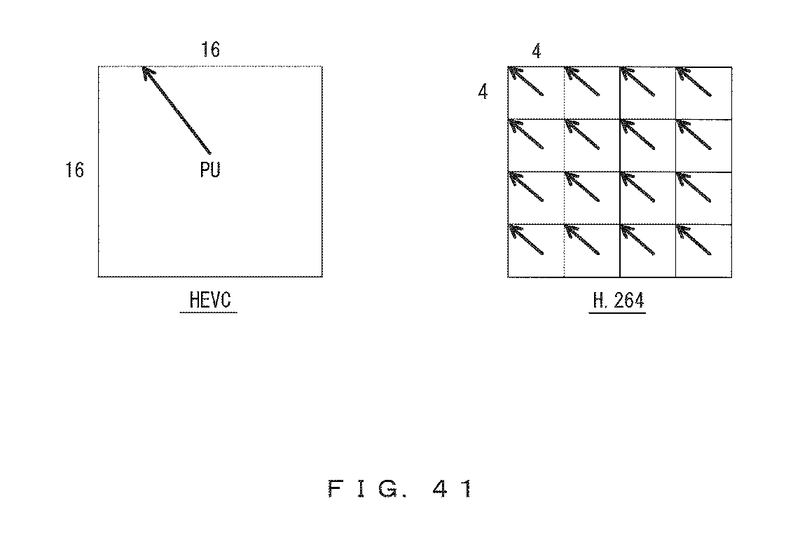

FIG. 41 illustrates an example of a correspondence relationship between a PU and an MB in a case in which the PU is 16×16. In a case in which an intra-prediction mode of HEVC is Angular (20), the mode converter 1113 divides the PU into sixteen 4×4 luminance blocks, and allocates mode 5 of H.264 to all of the luminance blocks.

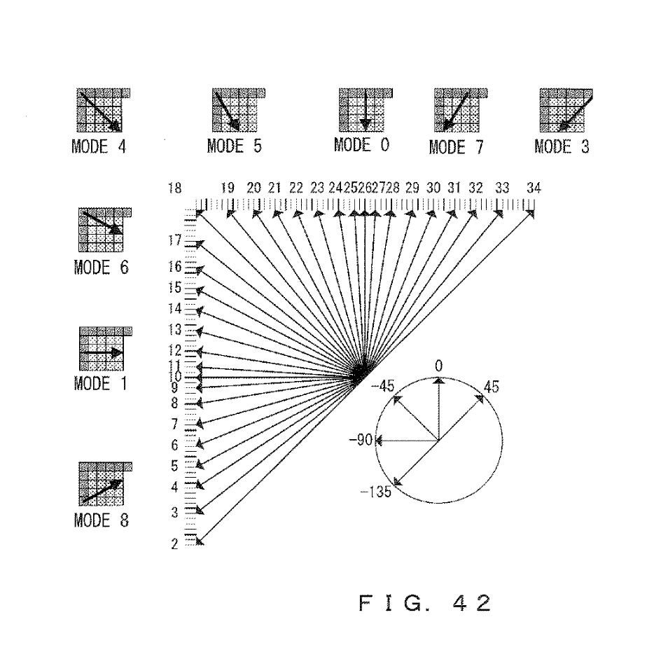

FIG. 42 illustrates an example of a correspondence relationship with a prediction direction in the case of (B). In this example, mode 8 of H.264 is allocated to Angular (2) to Angular (9) of HEVC, and mode 1 is allocated to Angular (11) to Angular (14). Mode 6 is allocated to Angular (15) and Angular (16), and mode 4 is allocated to Angular (17) to Angular (19).

Mode 5 is allocated to Angular (20) and Angular (21), and mode 0 is allocated to Angular (22) to Angular (25). Mode 7 is allocated to Angular (27) to Angular (30), and mode 3 is allocated to Angular (31) to Angular (34).

(C) A case in which the size of a PU according to HEVC is smaller than 16×16

In this case, the mode converter 1113 regards 16×16 blocks including the PU as one MB, divides the MB into sixteen 4×4 luminance blocks, and allocates a corresponding intra-prediction mode of H.264 to each of the luminance blocks.

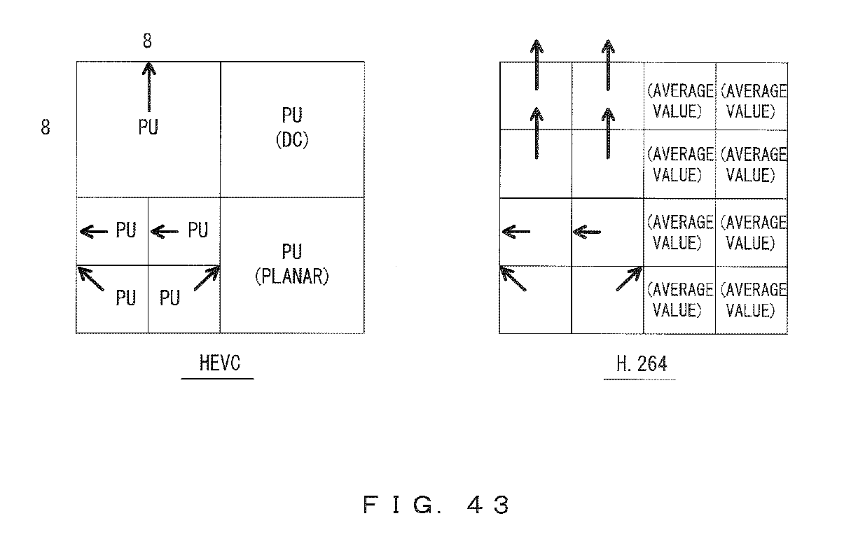

FIG. 43 illustrates an example of a correspondence relationship between a PU and an MB in a case in which the PU is smaller than 16×16. As an example, in a case in which the PU is 8×8, the mode converter 1113 divides the PU into four 4×4 luminance blocks, and allocates the same intra-prediction mode to all of the luminance blocks.

A method for determining an intra-prediction mode is similar to the method in the case of (B). However, an intra-prediction mode that corresponds to planar prediction does not exist according to H.264, and therefore mode 2 (average value) is allocated to planar prediction.

In a case in which a block to be encoded is a color difference block, when the size of a PU is greater than or equal to 8×8, the mode converter 1113 divides the PU into 8×8 color difference blocks, and allocates the same intra-prediction mode of H.264 to all of the color difference blocks. When the PU is 4×4, the mode converter 1113 uses the PU as a color difference block with no change.

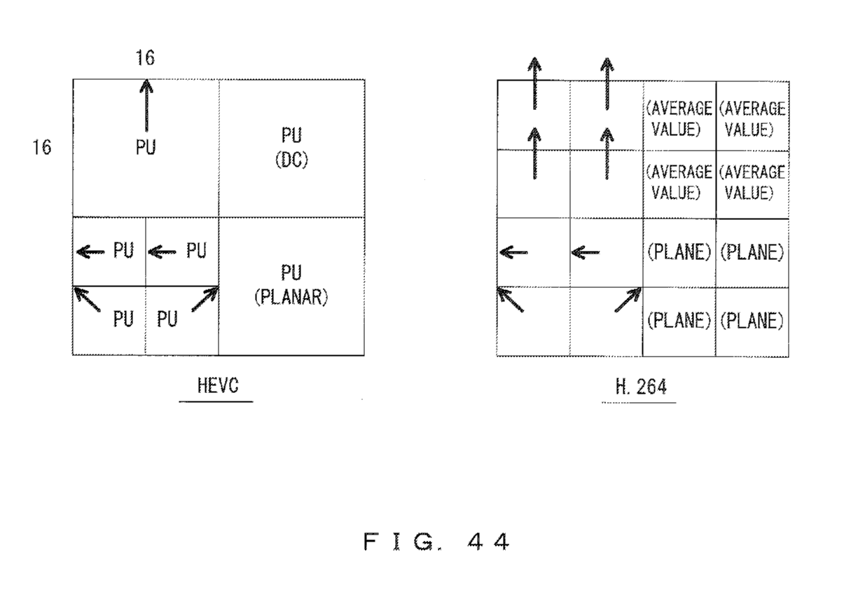

FIG. 44 illustrates an example of a correspondence relationship between a PU and a color difference block. As an example, when the PU is 8×8, the mode converter 1113 divides the PU into four 4×4 color difference blocks, and allocates the same intra-prediction mode to all of the color difference blocks.

A method for determining an intra-prediction mode is similar to the method in the case of (B) of the luminance block. Mode 0 (average value) is allocated to DC prediction, and mode 3 (plane) is allocated to planar prediction.

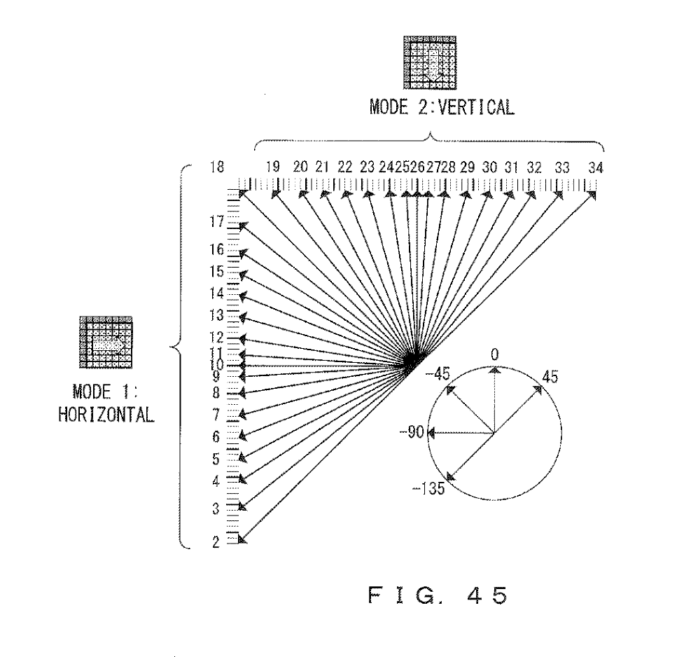

FIG. 45 illustrates an example of a correspondence relationship with a prediction direction in the case of a color difference block. In this example, mode 1 (horizontal) of H.264 is allocated to Angular (2) to Angular (18) of HEVC, and mode 2 (vertical) is allocated to Angular (19) to Angular (34).

Depending on the position of a block to be encoded according to H.264, a peripheral pixel in a position indicated by mode information that is output from the mode converter 1113 may fail to be encoded, and the decoded image storage 1114 may fail to store a decoded image including the peripheral pixel.

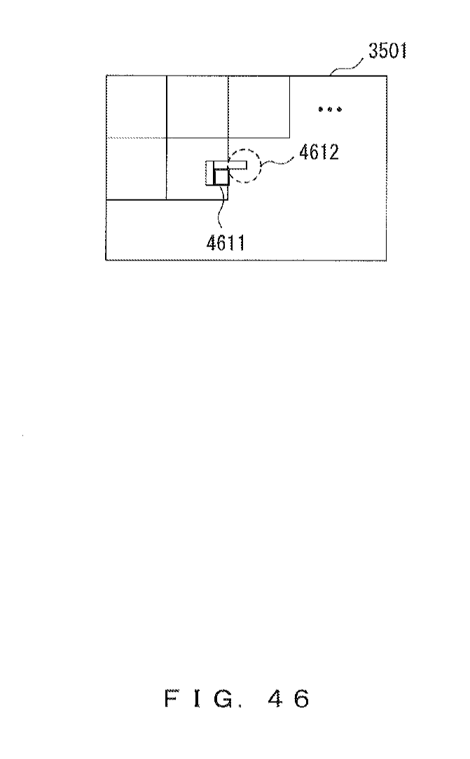

FIG. 46 illustrates an example of peripheral pixels that have not yet been encoded. In an image to be encoded 3501, a block on a right-hand side of a block to be encoded 4611 according to H.264 has not yet been encoded according to HEVC, and therefore a decoded image of peripheral pixels in an area 4612 has not yet been generated.

In the case of the H264 image encoding device 802 of FIG. 8, an image to be encoded is encoded in the raster order in units of 16×16 MBs, and therefore the above peripheral pixels that have not yet been encoded are not generated.

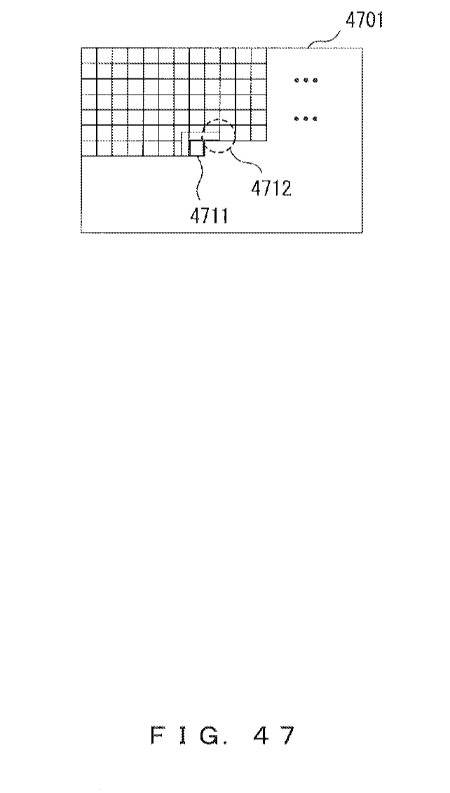

FIG. 47 illustrates an example of encoded peripheral pixels in the H264 image encoding device 802. In an image to be encoded 4701, an MB on an upper-right side of an image to be encoded 4711 according to H.264 has already been encoded, and therefore pixel values of peripheral pixels in an area 4712 can be referred to.

Accordingly, in a case in which a peripheral pixel that has not yet been encoded is generated, as in the area 4612 of FIG. 46, it is preferable that control be performed, for example, to encode the next block according to HEVC in advance before the block to be encoded 4611 is encoded.

The configurations of the image encoding device 101 of FIG. 1, the mode determination circuit 111 of FIG. 2, the encoder 112 of FIG. 7, and the image encoding system of FIG. 8 are examples, and some components may be omitted or changed according to the purpose or condition of the image encoding device 101 or the image encoding system.

The configurations of the image encoding device 901 of FIG. 9, the image encoding device 1101 of FIG. 11, the image encoding device 2301 of FIG. 23 or 31, and the image encoding device 2901 of FIG. 29 are examples, and some components may be omitted or changed according to the purpose or condition of the image encoding device. As an example, the frame memory 1102 may be provided within the image encoding device 1101, the image encoding device 2301, or the image encoding device 2901.

Some or all components of the adder 2315, the subtracter 2316, the difference decoder 2317, the quantization information storage 2318, the difference encoder 2319, and the difference image storage 2320 of FIG. 23 maybe provided outside the image encoding device 2301. The quantization information storage 2915 and the difference image storage 2916 of FIG. 29 may be provided outside the image encoding device 2901.

The configuration of the mode determination circuit 1131 of FIG. 21 is an example, and some components maybe omitted or changed according to the purpose or condition of the image encoding device 1101. The configurations of the difference encoder 2319 of FIG. 24, the difference decoder 2317 of FIG. 26, and the encoder 2922 of FIG. 30 are examples, and some components may be omitted or changed according to the purpose or condition of the image encoding device 2301 or the image encoding device 2901.

The flowcharts illustrated in FIGS. 10, 12, and 28 are examples, and some processes may be omitted or changed according to the configuration or condition of the image encoding device. As an example, in the image encoding processing of FIGS. 12 and 28, other algorithms such as H.261, H.262, H.263, MPEG-1, MPEG-2, or MPEG-4 may be used instead of HEVC and H.264.

The blocks of FIGS. 3, 5, 35, 46, and 47 are examples, and another block may be used according to the configuration or condition of the image encoding device. The motion vectors and the prediction directions of FIGS. 4 and 6 are examples, and another motion vector and another prediction direction may be used according to an input video signal.

The decoded image areas of FIGS. 13 and 22 are examples, and another decoded image area may be used according to the configuration or condition of the image encoding device. The methods of FIGS. 14 to 20 for converting a block and a motion vector are examples, and another converting method may be used according to the configuration or condition of the image encoding device. The quantization information storage 2318 and the difference image storage 2320 of FIGS. 25 and 33 are example, and another quantization information storage and another difference image storage may be used according to the configuration or condition of the image encoding device.

The reference area 2711 of FIG. 27 is an example, and another reference area may be used according to an input video signal. The accumulated generated-information amounts of FIGS. 32 and 34 are examples, and the accumulated generated-information amount varies according to an input video signal. The skip information of FIG. 33 is an example, and other skip information may be used according to the configuration or condition of the image encoding device.

The intra-prediction modes of FIGS. 36 to 39 are examples, and other intra-prediction modes may be used according to the configuration or condition of the image encoding device. The methods of FIGS. 40 to 45 for converting a block and an intra-prediction mode are examples, and another converting method may be used according to the configuration or condition of the image encoding device.

Expressions (1) to (3) are examples, and a QP value may be determined by using other calculation expressions in accordance with the configuration or condition of the image encoding device.

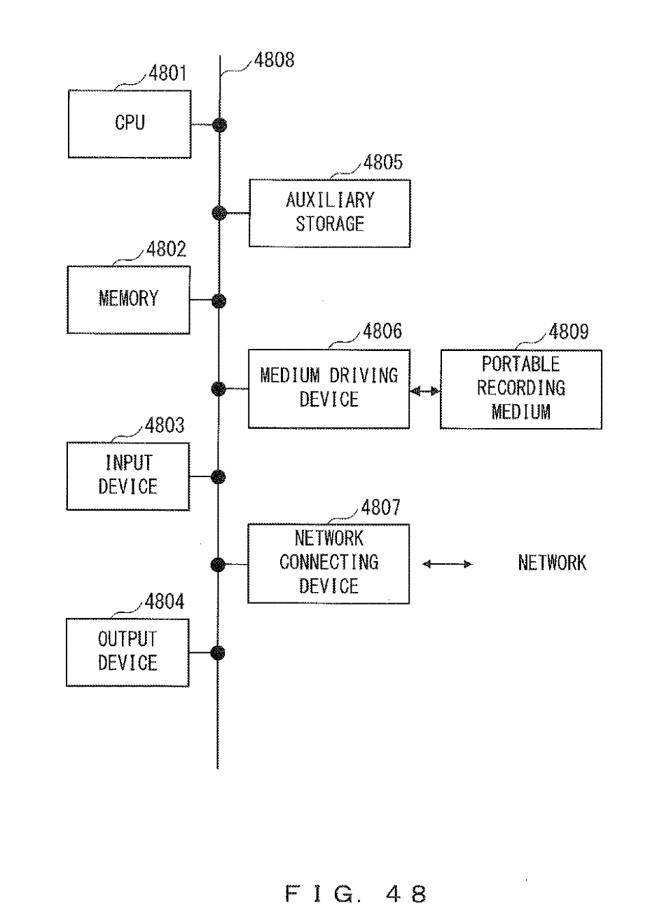

The image encoding devices of FIGS. 1, 9, 11, 23, 29, and 31 and the image encoding system of FIG. 8 can also be implemented as hardware circuits, and can also be implemented by using an information processing device (a computer) illustrated in FIG. 48.

The information processing device of FIG. 48 includes a central processing unit (CPU) 4801, a memory 4802, an input device 4803, an output device 4804, an auxiliary storage 4805, a medium driving device 4806, and a network connecting device 4807. These components are connected to each other via a bus 4808. The frame memory 102 of FIG. 1, the HEVC frame memory 803 and the H264 frame memory 804 of FIG. 8, the frame memories 1102 of FIGS. 11, 23, and 29 may be connected to the bus 4808.

The memory 4802 is a semiconductor memory such as a read only memory (ROM), a random access memory (RAM), or a flash memory, and the memory 4802 stores a program and data used in image compression processing. The memory 4802 can be used as the decoded image storage 914 of FIG. 9, the decoded image storage 1114 of FIG. 11, the decoded image storage 2314 of FIG. 23, and the decoded image storage 2914 of FIG. 29. The memory 4802 can also be used as the quantization information storage 2318 and the difference image storage 2320 of FIG. 23, and the quantization information storage 2915 and the difference image storage 2916 of FIG. 29.

The CPU 4801 (a processor) operates as the mode determination circuit 111 and the encoder 112 of FIG. 1, for example, by executing a program by using the memory 4802. The CPU 4801 also operates as the intra-prediction circuit 201, the inter-prediction circuit 202, and the selector 203 of FIG. 2, and the converter 701, the inverse converter 702, and the entropy encoder 703 of FIG. 7. The CPU 4801 also operates as the HEVC image encoding device 801, the H264 image encoding device 802, the mode determination circuit 811, the encoder 812, the mode determination circuit 821, and the encoder 822 of FIG. 8.

The CPU 4801 also operates as the encoder 911, the encoder 912, and the converter 913 by executing a program by using the memory 4802. The CPU 4801 also operates as the HEVC encoder 1111, the H264 encoder 1112, the mode converter 1113, the mode determination circuit 1121, the encoder 1122, the mode determination circuit 1131, and the encoder 1132 of FIG. 11. The CPU 4801 also operates as the intra-prediction circuit 2101 and the selector 2102 of FIG. 21.

The CPU 4801 also operates as the HEVC encoder 2311, the H264 encoder 2312, and the mode converter 2313 of FIG. 23 by executing a program by using the memory 4802. The CPU 4801 also operates as the adder 2315, the subtracter 2316, the difference decoder 2317, the difference encoder 2319, the mode determination circuit 2321, the encoder 2322, the mode determination circuit 2331, and the encoder 2332.

The CPU 4801 also operates as the HEVC encoder 2911, the H264 encoder 2912, and the mode converter 2913 of FIG. 29 by executing a program by using the memory 4802. The CPU 4801 also operates as the mode determination circuit 2921, the encoder 2922, the mode determination circuit 2931, and the encoder 2932. The CPU 4801 also operates as the selectors 3002 to 3007, the converter 3008, the encoder 3009, the inverse converter 3010, the decoder 3011, the controller 3012, and the controller 3013 of FIG. 30. The CPU 4801 also operates as the rate controller 3101, the switch 3102, and the switch 3103 of FIG. 31.

The input device 4803 is, for example, a keyboard, a pointing device, or the like, and the input device 4803 is used to input an instruction or information from a user or an operator. The output device 4804 is, for example, a display device, a printer, a speaker, or the like, and the output device 4804 is used to output inquiry or a processing result to a user or an operator.

The auxiliary storage 4805 is, for example, a magnetic disk device, an optical disk device, a magneto-optical disk device, a tape device, or the like. The auxiliary storage 4805 may be a hard disk drive. The information processing device can store a program and data in the auxiliary storage 4805, and can use them by loading them onto the memory 4802.

The medium driving device 4806 drives a portable recording medium 4809, and accesses the contents recorded therein. The portable recording medium 4809 is a memory device, a flexible disk, an optical disk, a magneto-optical disk, or the like. The portable recording medium 4809 may be a compact disk read only memory (CD-ROM), a digital versatile disk (DVD), or a universal serial bus (USB) memory. A user or an operator can store a program and data in the portable recording medium 4809, and can use them by loading them onto the memory 4802.

As described above, a computer-readable recording medium that stores a program and data used in processing is a physical (non-transitory) recording medium such as the memory 4802, the auxiliary storage 4805, or the portable recording medium 4809.

The network connecting device 4807 is a communication interface that is connected to a communication network such as a local area network (LAN) or the internet, and that performs data conversion associated with communication. The network connecting device 4807 can transmit an encoded stream to the image decoding device. The information processing device can receive a program and data from an external device via the network connecting device 4807, and can use them by loading them onto the memory 4802.

The information processing device does not need to include all of the components illustrated in FIG. 48, and some of the components can be omitted according to the purpose or condition. As an example, in a case in which an interface with a user or an operator is not needed, the input device 4803 and the output device 4804 may be omitted. In a case in which the information processing device does not access the portable recording medium 4809, the medium driving device 4806 may be omitted.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image encoding device comprising:
a first encoder that encodes an input image by using a first encoding algorithm;
a first memory that stores a decoded image obtained by decoding a code generated by the first encoder;
a converter that converts a shape of a block of the input image that is segmented into a plurality of blocks; and
a second encoder that encodes the block converted by the converter according to the decoded image by using a second encoding algorithm that is different from the first encoding algorithm.

2. The image encoding device according to claim 1, wherein
the first encoder refers to the decoded image, and encodes the block of the input image by using first prediction encoding according to the first encoding algorithm, the converter converts the shape of the block of the input image into a shape used in second prediction encoding according to the second encoding algorithm, and the second encoder refers to the decoded image, and encodes the converted block by using the second prediction encoding.

3. The image encoding device according to claim 1, further comprising:
a second memory that stores a difference image indicating a difference between the decoded image and a decoded image that is obtained by decoding a code generated by the second encoder, wherein
the first encoder refers to the decoded image obtained by decoding the code generated by the first encoder, and encodes the block of the input image by using first prediction encoding according to the first encoding algorithm, the converter converts the shape of the block of the input image into a shape used in second prediction encoding according to the second encoding algorithm, and the second encoder refers to a decoded image that is generated from the decoded image stored in the first memory and the difference image, and encodes the converted block by using the second prediction encoding.

4. The image encoding device according to claim 3, further comprising:
a difference encoder that encodes the difference image, and generates a difference code; and
a difference decoder that decodes the difference code, and generates the difference image, wherein
the second memory stores the difference code, and the difference decoder decodes the difference code stored in the second memory and generates the difference image.

5. The image encoding device according to claim 4, further comprising:
a controller that controls a compression ratio in encoding the difference image in accordance with a writing information amount that is generated in writing the difference code to the second memory, a reading information amount that is generated in reading the difference code from the second memory, and a target information amount.

6. The image encoding device according to claim 5, wherein
the controller skips an operation to write the difference code to the second memory when the writing information amount is smaller than a prescribed value.

7. The image encoding device according to claim 6, wherein
the controller skips an operation to read the difference code from the second memory when the operation to write the difference code to the second memory is skipped.

8. The image encoding device according to claim 5, wherein
the controller inhibits the operation to write the difference code to the second memory and the operation to read the difference code from the second memory when an accumulated value of the writing information amount and the reading information amount reaches an upper limit value.

9. The image encoding device according to claim 3, wherein
the first encoder encodes the difference image and generates a difference code, the second memory stores the difference code, and the first encoder generates the difference image from a decoding result of decoding the difference code stored in the second memory.

10. The image encoding device according to claim 9, further comprising:
a controller that controls a compression ratio in encoding the difference image in accordance with a writing information amount that is generated in writing the difference code to the second memory, a reading information amount that is generated in reading the difference code from the second memory, and a target information amount.

11. The image encoding device according to claim 10, wherein
the controller skips an operation to write the difference coder to the second memory when the writing information amount is smaller than a prescribed value.

12. The image encoding device according to claim 11, wherein
the controller skips an operation to read the difference coder from the second memory when the operation to write the difference code to the second memory is skipped.

13. The image encoding device according to claim 10, wherein
the controller inhibits the operation to write the difference code to the second memory and the operation to read the difference code from the second memory when an accumulated value of the writing information amount and the reading information amount reaches an upper limit value.

14. The image encoding device according to claim 1, wherein
the converter determines a motion vector of the converted block in accordance with a motion vector of the block of the input image when the first prediction encoding and the second prediction encoding are inter-prediction encoding.

15. The image encoding device according to claim 1, wherein
the converter determines an intra-prediction mode of the converted block in accordance with an intra-prediction mode of the block of the input image when the first prediction encoding and the second prediction encoding are intra-prediction encoding.

16. An image encoding method comprising:
encoding, by an image encoding device, an input image by using a first encoding algorithm;
storing, by the image encoding device, a decoded image obtained by decoding a code generated according to the first encoding algorithm in a memory;
converting, by the image encoding device, a shape of a block of the input image that is segmented into a plurality of blocks; and
encoding, by the image encoding device, the converted block according to the decoded image by using a second encoding algorithm that is different from the first encoding algorithm.

17. The image encoding method according to claim 16, wherein
the encoding the input image refers to the decoded image, and encodes the block of the input image by using first prediction encoding according to the first encoding algorithm,
the converting the shape of the block converts the shape of the block of the input image into a shape used in second prediction encoding according to the second encoding algorithm, and
the encoding the converted block refers to the decoded image, and encodes the converted block by using the second prediction encoding.

18. The image encoding method according to claim 16, further comprising:
storing, by the image encoding device, a difference image in a second memory, the difference image indicating a difference between the decoded image and a decoded image that is obtained by decoding a code generated according to the second encoding algorithm, wherein
the encoding the input image refers to the decoded image obtained by decoding the code generated according to the first encoding algorithm, and encodes the block of the input image by using first prediction encoding according to the first encoding algorithm,
the converting the shape of the block converts the shape of the block of the input image into a shape used in second prediction encoding according to the second encoding algorithm, and
the encoding the converted block refers to a decoded image that is generated from the decoded image stored in the first memory and the difference image, and encodes the converted block by using the second prediction encoding.
